(19) United States
(12) Patent Application Publication
(10) Pub. No.: US 2013/0304522 A1
(43) Pub. Date: Nov. 14, 2013

(54) COMPUTER BASED METHOD OF MANAGING, SAVING FOR, AND ARRANGING TRAVEL

(71) Applicant: Heddi Cundle, San Francisco, CA (US)

(72) Inventor: Heddi Cundle, San Francisco, CA (US)

(21) Appl. No.: 13/797,660

(22) Filed: Mar. 12, 2013

Related U.S. Application Data
(60) Provisional application No. 61/645,784, filed on May 11, 2012.

(51) Int. Cl. G06Q 10/02

(52) U.S. Cl. CPC G06Q 10/02
USPC 705/5

(57) ABSTRACT

The invention is a computer-based method of saving for and booking travel arrangements. The method generally includes a full service travel website and computer accessible interest bearing bank account that is set up for the express purpose of saving funds for future travel. The method preferably includes a reward system that allows users to pay for travel with the savings account funds, interest from the account, and the rewards points. The method also preferably includes notification mechanisms and gifting mechanisms to allow the transfer of funds between users for the booking of travel.

### CROSS-REFERENCE TO RELATED APPLICATIONS

This application takes priority from U.S. Provisional Patent Application No. 61/645,784, filed on May 11, 2012, titled “A Computer Based Method of Managing, Saving for, and Arranging Travel”, by inventor Heddi Cundle, the contents of which are expressly incorporated herein by this reference as though set forth in their entirety, and to which priority is claimed.

### FIELD OF INVENTION

This invention generally relates to a computer-based method of saving funds for travel expenses and booking trips using the saved funds. More particularly, the invention is a computer-based travel account bank and/or gift card that encourages a user to save funds for trips and provides a user booking travel options.

### BACKGROUND

The proliferation of the Internet has created various types of travel comparison, shopping, and booking websites. Travel comparison website providers, such as Expedia® and Travelocity®, allow users to compare prices for hotels, airline flights, rental cars, and other travel related items. These travel comparison website providers primarily focus on providing users with a list of current prices to compare as they look to book travel arrangements. The ability for the consumer to compare prices has led to an over emphasis on price by the consumer and the travel comparison website provider. Moreover, the prices displayed on any particular travel comparison website are often the same on any of the other travel comparison websites.

Because the travel provider, such as the airlines and hotels, have their own website, users of the travel comparison websites will frequently go to the provider websites directly to see if the price is the same and, if it is the same or less, book the travel directly with the provider. Indeed, consumers will often visit several comparison websites and provider websites before booking travel arrangements. The ability for users to quickly compare several websites and the ability of the travel providers to undercut the travel comparison websites has led to a lack of loyalty among consumers to a particular travel comparison website. Price, rather than loyalty, is the driving concern.

One method of encouraging loyalty to a particular travel provider or website is the reward system based upon a user's frequent use. Specifically, with this system, a user is rewarded for her frequent use of a travel provider. When enough reward points are generated, the user can use the reward points to book travel with that particular provider. Although this helps with loyalty, there is still a good chance that the user may forgo the opportunity to get rewards points if the cost of using another provider is less than the reward granting provider. For example, statistics have even shown that purchasing trips with mileage in combination with money typically costs more than trips that are purchased with cash alone during blackouts and restrictions. While a rewards program may reduce the cost impact of a purchase, (due to any disillusionment towards the user), the user may still compare the cost of a trip by one supplier with another supplier when searching for travel options. Once a customer who has gathered substantial reward points for a particular travel plan discovers a cheaper travel plan that is only available by cash payment alone, that customer may feel that his or her value is unappreciated. As a result, that customer will likely purchase from the cheaper travel provider, further illustrating that price is the determinative factor.

Another issue not addressed by the travel providers or comparison websites is the promotion of green travel. Due to the current concern for the environment that many consumers have, many travelers have expressed a desire to travel in a more ecological or environmental friendly way. However, neither the providers nor the comparison websites offer information on how green a particular travel option may be or offer incentives to select that green travel option, especially within the mainstream consumer audience. Although green travel is generally denoted as “niche,” many travel suppliers do offer partial green initiatives, further classifying the supplier as promoting green.

Furthermore, conventional websites generally lack a mechanism that provides a notification to friends and family members about the booking of a trip by a particular user. For example, when a person desires to travel abroad but lacks the funds to do so, many friends and/or family members may want to assist that person with the person's travel expenses. However, due to the possibility of misuse of cash, friends and family members may be deterred from providing cash to others. This generally occurs because friends or family members typically do not see their end results of their cash gifting to the recipient, which in turn reduces the emotional intention behind the cash. Furthermore, websites that do offer cash transactions for gifting typically charge fees ranging approximately between six to ten percent, thereby also losing the value of the gifted cash.

Finally, the difficulty of coordinating planned trips with groups of people has also become a common issue for conventional websites. When more than one person is involved, it sometimes becomes problematic for people to coordinate the same flights, hotels, and travel options, especially when purchasing airline tickets and hotel lodgings from a conventional travel website. This often results with plans that falter within travel groups, as group travelers have a tendency to drift apart over time. Usually, an assigned leader of the group plans and coordinates and even may pay the full funds, with the intention of recouping the full costs back. This often creates a communication breakdown and stress between travelers and the organizer who ended paying up out of his or her pocket.

There are several references that disclose methods of using computer-based systems to aid a traveler in comparing and booking travel arrangements. For example, U.S. Pat. No. 5,948,040, issued to DeLorme, U.S. Pat. No. 7,599,847, issued to Block, and U.S. Published Application No. 2002/0010604, filed by Block, each disclose various travel reservation, information, and planning systems for individuals. In the area of corporate planning and management of business travel, U.S. Pat. No. 6,442,526 to Vance discloses a system and method for processing travel data and travel receipts for the business traveler. Finally, U.S. Published Application No. 2001/0037243, filed by Rouston, discloses a system for accruing and redeeming frequent flyer miles.

Other reference also discloses methods using computer-based systems to aid with travel arrangements. For example, U.S. Published Application No. 2009/0210262, filed by Rines, discloses a method and apparatus for travel using various computers. Specifically, the system disclosed in Rines identifies appointment data associated with a scheduling application and automatically researches travel arrangements according to the appointment data. Additionally, U.S. Published Application No. 2009/0094110, filed by Hoque discloses a flexible savings system that combines benefits of a layaway payment plan. The end user in the Hoque reference has the flexibility as to how much to save, when to save, and for what to save. Finally, U.S. Published Application 2010/0145743, filed by Colquhoun discloses a system for carbon offsetting a travel product.

Although the above references disclose various mechanisms for managing travel arrangements such as booking travel arrangements, comparing prices, and redeeming rewards, none of the references is directed towards, or even hints at a computer-based method or system that would reward loyalty, offer green travel alternatives, provide notification mechanisms to encourage the transfer of funds, allow users to access discounted travel, and provide a travel savings account or gift card to save up money for future travel.

Therefore, what is needed is a computer-based method for managing travel that helps a user to save funds while, at the same time, provide various notification and coordinating mechanisms for travelers to provide funds and coordinate within the same group. Preferably, the computer-based method provides a mechanism that allows for real time cash gifting to a recipient's account within a socially integrated platform that promotes a full-life cycle from gifting, saving, planning, sharing, booking travel, and thanking contributors.

### SUMMARY OF THE INVENTION

To minimize the limitations in the prior art, and to minimize other limitations that will become apparent upon reading and understanding the present specification, the present invention discloses a computer-aided method of saving funds for travel expenses and booking travel arrangements using the saved fund.

One embodiment of the invention is a computer-based method of managing travel arrangements, the steps comprising: registering on a computer by a user on a system for managing travel; wherein the system for managing travel is on a server; creating a designated travel savings account; linking the designated travel savings account to the system for managing travel; accessing on the computer by the user the system for managing travel; providing on a computer a plurality of travel options on the system for managing travel the user accessing the system for managing travel; selecting by the user one or more of the plurality of travel options on the system for managing travel; and paying for the selected one or more travel options from a set of saved funds in the designated travel savings account. Preferably the steps further comprise: rewarding the user with one or more rewards points. The reward points may be based on saving a plurality of funds in the designated travel savings account, donating to a charity, donating to a carbon offset, purchasing travel insurance from the system for managing travel with the set of saved funds in the designated travel savings account, or purchasing selected one or more travel options from the system for managing travel with the set of saved funds in the designated travel savings account. The rewards points may be used by the user to offset paying for the selected one or more travel options.

Preferably the travel options provided on the system for managing travel to the user accessing the system for managing travel includes green travel options. The designated travel savings account preferably accrues interest. The user and any third party may add additional funds to the set of saved funds in the designated travel savings account. The travel options preferably include one or more exclusive deals to registered users from a plurality of travel providers.

Another embodiment of the present invention is a computer-based method of managing travel arrangement preferably include the steps of: providing a calendar alert function within the system for managing travel; inputting a plurality of calendar alert data into the calendar alert function; wherein the plurality of calendar alert data is selected from the group consisting of future trip data, wish list data, third party gift giving data, personal gift giving data, popular event data, available funds data, funds needed to book a future trip data, and exclusive deals data; notifying the user by the calendar alert function of one or more of the plurality of calendar alert data; modifying and updating the plurality of calendar alert data; personalizing the system for managing travel; and personalizing the plurality of calendar alert data. The user may be notified by the calendar alert function of one or more of the plurality of calendar alert data by an email notification, a text notification, a smart phone application notification, or a desktop application notification.

Another embodiment is a computer-based method of managing travel arrangements, the steps comprising: registering on a computer by one or more users on a system for managing travel; wherein the system for managing travel is on a server; creating a gift card; wherein the gift card functions as a travel savings account; linking the gift card to the system for managing travel; accessing on the computer by the one or more users the system for managing travel; providing on a computer a plurality of travel options on the system for managing travel to the one or more users accessing the system for managing travel; wherein the plurality of travel options on the system for managing travel is provided by one or more suppliers; wherein the providing step of the plurality of travel options is generated based upon the set amount of saved funds saved in the gift card; selecting by the one or more users one or more travel options on the system for managing travel; and paying for the selected one or more travel options from the set amount of saved funds. Preferably, the computer-based method of managing travel arrangements further comprises the steps: rewarding the one or more users with one or more rewards points; wherein the one or more rewards points are applied to redeem the plurality of travel options; and alerting the one or more users one or more expiration dates of the one or more rewards points. Preferably, the one or more rewards points is based on saving a plurality of funds in the gift card; and the one or more rewards points is preferably based on purchasing the plurality of travel options. The set amount to generate the plurality of travel options may be approximately 15% more of the set saved funds in the designated travel savings account. The set amount to generate the plurality of travel options may be approximately 15% less of the set saved funds in the designated travel savings account. The selecting step of the one or more travel options may produce a notification on one or more social media sites. The one or more rewards points may be based on purchasing selected one or more travel options from the system for managing travel with the set of saved funds in the designated travel savings account. The rewards points may be used by the one or more users to offset paying for the selected one or more travel options. The notification on one or more social media sites may be one or more postings on the one or more social media sites. A plurality of the one or more users may be a travel group; and the selecting of the one or more travel options by the one or more users may create an alert to the travel group. One or more third parties may add a plurality of additional funds to the set of saved funds in the gift card. The plurality of travel options may include one or more exclusive deals to one or more registered users from a plurality of travel providers. The computer-based method of managing travel arrangements may further comprise the steps of: providing a calendar alert function within the system for managing travel; inputting a plurality of calendar alert data into the calendar alert function; wherein the plurality of calendar alert data may be selected from the group consisting of future trip data, wish list data, third party gift giving data, personal gift giving data, popular event data, available funds data, funds needed to book a future trip data, and exclusive deals data; notifying the one or more users by the calendar alert function of one or more of the plurality of calendar alert data. The computer-based method of managing travel arrangements may further comprise the step of modifying and updating the plurality of calendar alert data. The computer-based method of managing travel arrangements may further comprise the step of: personalizing the system for managing travel; personalizing the plurality of calendar alert data; and creating a wish list of the one or more travel options. The one or more users may be notified by the calendar alert function of one or more of the plurality of calendar alert data by the group consisting of an email notification, a text notification, a smart phone application notification, and a desktop application notification. The selecting step of the one or more travel options may produce a notification on one or more social media sites. The wish list of the one or more travel options may be posted in one or more social media sites. The plurality of travel options may include one or more exclusive deals to one or more registered users from a plurality of travel providers; wherein the one or more exclusive deals may be based upon approximately a 15% threshold of set saved and/or gifted funds in the gift card.

Another embodiment of the present invention is a computer-based method of managing travel arrangements, the steps comprising: registering on a computer by a one or more users on a system for managing travel; wherein the system for managing travel is on a server; creating a gift card; wherein the gift card functions as a savings account; linking the gift card to the system for managing travel; accessing on the computer by the one or more users the system for managing travel; providing on a computer a plurality of travel options on the system for managing travel to the one or more users accessing the system for managing travel; wherein the plurality of travel options on the system for managing travel is provided by one or more suppliers; wherein the providing step of the plurality of travel options is generated based upon the set amount of saved funds saved in the gift card; selecting by the one or more users one or more travel options on the system for managing travel; paying for the selected one or more travel options from the set amount of saved and or gifted funds in the gift card; rewarding the one or more users with one or more rewards points; wherein the one or more rewards points are applied to redeem the plurality of travel options; alerting the one or more users one or more expiration dates of the one or more rewards points; wherein the one or more rewards points is based on purchasing the plurality of travel options; wherein the selecting step of the one or more travel options produces a notification on one or more social media sites; wherein the notification on one or more social media sites is one or more postings on the one or more social media sites; wherein one or more third parties may add a plurality of additional funds to the set of saved funds in the gift card; wherein the plurality of travel options includes one or more exclusive deals to one or more registered users from a plurality of travel providers; providing a calendar alert function within the system for managing travel; inputting a plurality of calendar alert data into the calendar alert function; wherein the plurality of calendar alert data is selected from the group consisting of future trip data, wish list data, third party gift giving data, personal gift giving data, popular event data, available funds data, funds needed to book a future trip data, and exclusive deals data; notifying the one or more users by the calendar alert function of one or more of the plurality of calendar alert data; wherein the one or more users is notified by the calendar alert function of one or more of the plurality of calendar alert data by the group consisting of an email notification, a text notification, a smart phone application notification, and a desktop application notification; creating a wish list of the one or more travel options; modifying and updating the plurality of calendar alert data; personalizing the system for managing travel; and personalizing the plurality of calendar alert data.

Another embodiment of the present invention is a computer-based method of managing travel arrangements, the steps comprising: registering on one or more computers by one or more users on a system for managing travel; wherein the system for managing travel is on a server; creating one or more gift cards; wherein each of the one or more gift cards functions as a travel savings account; linking the one or more gift cards to the one or more registered users of the system for managing travel; accessing on the one or more computers by the one or more users the system for managing travel; providing on the one or more computers a plurality of travel options to the one or more users accessing the system for managing travel; wherein the plurality of travel options on the system for managing travel is provided by one or more suppliers; wherein the providing step of the plurality of travel options is generated based upon the set amount of funds saved by a first registered user in the linked gift card of the first registered user's linked gift card; selecting by the first registered user one or more of the plurality of travel options on the system for managing travel; providing one or more notifications to the first registered user after the first registered user selects one or more of the plurality of travel options; and paying for the selected one or more of the plurality of travel options from the set amount of funds saved in the first registered user's linked gift card. Preferably, the computer-based method of managing travel arrangements further comprises the steps of: rewarding the one or more users with one or more rewards points; wherein the one or more rewards points are applied to redeem the plurality of travel options; and alerting the one or more users one or more expiration dates of the one or more rewards points. Preferably, the one or more rewards points is based on saving a plurality of funds in the one or more gift cards; and wherein the one or more rewards points is based on purchasing the one or more of the plurality of travel options. The set amount to generate the plurality of travel options may be approximately within a threshold between −15% to 15% of the set saved funds in the gift card. The set amount to generate the plurality of travel options may be approximately within a threshold between −20% to 20% of the set amount of funds saved in the one or more gift cards. The providing step of the one or more notifications may be performed in one or more social media sites. The one or more rewards points may be based on purchasing selected one or more of the plurality of travel options from the system for managing travel with the set amount of funds saved in the one or more gift cards. The one or more rewards points may be used by the one or more users to offset paying for the selected one or more of the plurality of travel options. The notification on one or more social media sites may be one or more postings in the one or more social media sites. The one or more users may be a plurality of users and wherein the plurality of users form a travel group; and the steps may further comprise of: selecting by the travel group the one or more of the plurality of travel options; and providing one or more notifications to the travel group after the travel group selects the one or more of the plurality of travel options. One or more third parties may add a plurality of additional funds to the set amount of funds saved in the one or more gift cards. The plurality of travel options may include one or more exclusive deals to the one or more registered users from the one or more suppliers. The computer-based method of managing travel arrangements may further comprise the steps of: providing a calendar alert function within the system for managing travel; inputting a plurality of calendar alert data into the calendar alert function; wherein the plurality of calendar alert data is selected from the group of data consisting of: future trip data; wish list data; third party gift giving data; personal gift giving data; popular event data; available funds data; funds needed to book a future trip data; and exclusive deals data; and notifying the one or more users by the calendar alert function of one or more of the plurality of calendar alert data. The computer-based method of managing travel arrangements may further comprise the steps of: modifying and updating the plurality of calendar alert data. The computer-based method of managing travel arrangements may also further comprise the steps of: personalizing the system for managing travel; personalizing the plurality of calendar alert data; and creating a wish list of the plurality of travel options. The one or more users may be notified by the calendar alert function of one or more of the plurality of calendar alert data by the group consisting of: an email notification; a text notification; a smart phone application notification; and a desktop application notification. The selecting step of the one or more of the plurality of travel options may produce a notification on one or more social media sites. The wish list of the plurality of travel options may be posted in one or more social media sites. The plurality of travel options may include one or more exclusive deals to one or more registered users from a plurality of suppliers; and wherein the one or more exclusive deals may be based upon approximately within a threshold between −15% to 15% of the set amount of funds saved in the one or more gift cards.

Another embodiment of the present invention may be a computer-based method of managing travel arrangements, the steps comprising: registering on one or more computers by one or more users on a system for managing travel; wherein the system for managing travel is on a server; creating one or more gift cards; wherein each of the one or more gift cards functions as a travel savings account; linking the one or more gift cards to the one or more registered users of the system for managing travel; accessing on the one or more computers by the one or more users the system for managing travel; providing on the one or more computers a plurality of travel options to the one or more users accessing the system for managing travel; wherein the plurality of travel options on the system for managing travel is provided by one or more suppliers; wherein the plurality of travel options includes one or more exclusive deals to the one or more registered users from the one or more suppliers; wherein the providing step of the plurality of travel options is generated based upon the set amount of funds saved by a first registered user in the linked gift card of the first registered user's linked gift card; wherein the set amount to generate the plurality of travel options is approximately within a threshold between −15% to 15% of the set saved funds in the gift card; selecting by the first registered user one or more of the plurality of travel options on the system for managing travel; providing one or more notifications to the first registered user after the first registered user selects one or more of the plurality of travel options; wherein the selecting step of the one or more of the plurality of travel options produces a notification on one or more social media sites; wherein the providing step of the one or more notifications is performed in one or more social media sites; wherein the notification on one or more social media sites is one or more postings in the one or more social media sites; paying for the selected one or more of the plurality of travel options from the set amount of funds saved in the first registered user's linked gift card; rewarding the one or more users with one or more rewards points; wherein the one or more rewards points is based on saving a plurality of funds in the one or more gift cards; wherein the one or more rewards points is based on purchasing the one or more of the plurality of travel options; wherein the one or more rewards points are used by the one or more users to offset paying for the selected one or more of the plurality of travel options; wherein the one or more rewards points are applied to redeem the plurality of travel options; alerting the one or more users one or more expiration dates of the one or more rewards points; wherein a the one or more users is a plurality of users and wherein the plurality of users form a travel group; selecting by the travel group the one or more of the plurality of travel options; providing one or more notifications to the travel group after the travel group selects the one or more of the plurality of travel options; wherein one or more third parties add a plurality of additional funds to the set amount of funds saved in the one or more gift cards; providing a calendar alert function within the system for managing travel; inputting a plurality of calendar alert data into the calendar alert function; wherein the plurality of calendar alert data is selected from the group of data consisting of: future trip data; wish list data; third party gift giving data; personal gift giving data; popular event data; available funds data; funds needed to book a future trip data; and exclusive deals data; notifying the one or more users by the calendar alert function of one or more of the plurality of calendar alert data; wherein the one or more users are notified by the calendar alert function of one or more of the plurality of calendar alert data by the group consisting of: an email notification; a text notification; a smart phone application notification; and a desktop application notification; modifying and updating the plurality of calendar alert data; personalizing the system for managing travel; personalizing the plurality of calendar alert data; creating a wish list of the plurality of travel options; wherein the wish list of the plurality of travel options is posted in one or more social media sites.

Various embodiments of the invention improve the ability of individuals and businesses to fund their travels objectives. The invention provides for a designated savings account, gift card, and a reward system for using the savings account/gift card to save for and pay for travel arrangements and vertical online markets such as home decor, sporting goods, appliances, consumer electronics, automobiles, clothing, and financial institute lifestyle reward program incentives.

It is an object of the present invention to psychologically separate general everyday savings from travel savings, which encourages travel objectives to be reached.

It is an object of the present invention to provide a savings account and/or travel gift card to save travel funds with notification mechanisms, so friends and family may contribute to the user's travel fund. The user may then redeem funds towards travel, from numerous flights and hotels, travel related products, and attractions within the website of the present invention. Preferably, the present invention may allow negotiations with exclusive supplier deals within a certain threshold (e.g., 15%) of the user's travel funds.

It is an object of the present invention to allow registered members to get rewarded for the amount of money they have in their account and stretch their funds further though exclusive supplier deal negotiations. The rewards points are preferably only spendable on the full service online travel website. In order to encourage ecologically friendly travel, the users can also get rewards points by making a carbon offset donation or an ecologically friendly or green donation. Rewards points are also granted based on actual travel purchases and travel insurance purchases.

It is also an object of the present invention to provide a method for saving funds; wherein the funds may be used for a designated website and any online travel agents and suppliers featured by the designated website. This preferably results with loyalty among the users and suppliers of the computer-based method and the stabilization of prices within suppliers for slow times and long leads at a fraction of their traditional marketing and advertising costs to a captured, funded, travel demographic. This program is preferably called “Match myCash” generated by analyzing the pre travel data by users and matching this to supplier bid offerings.

It is also an object of the present invention to provide a notification mechanism for other travel users such as group travelers. For example, regarding group accounts, once a trip is booked by one individual in the group, other group travelers may be notified by the computer-based method of the individual's travel purchase, especially for exclusive offers and non-exclusive travel. Other group travelers may also be notified in order to allow the rest of the group to book the same travel. Preferably, the present invention to notify friends of other users that a trip is booked on any social media plug-in such as Facebook® and Twitter®.

It is also an object to of the present invention to allow users to add funds to their account in real-time at the time of booking.

It is also an object of the present invention to provide a calendar and alert system to allow users to set up reminders and receive alerts regarding their travel plans.

It is also an object of the present invention is to leverage the funds in the various travel accounts of the members to provide exclusive and bargain deals to the members through crowd funded initiatives.

It is also an object of the present invention to engender the loyalty of the members so that they use the present invention to save for, receive travel gifted cash, and book all of their travel.

It is an object of the present invention to overcome limitations of the prior art.

It is an object of the present invention to revolutionize the way individuals and businesses plan, pay for travel, and pioneer in ecommerce with travel and verticals such as financial services, home decor, sporting goods, appliances, consumer electronics, automobiles and clothing.

The present invention will be accessible via social media outlets or via smart phone, computer applications, tablets, and other consumer related electronic devices.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

FIG. 1 is a flow block diagram and shows the initial registration steps of one embodiment of the present invention.

FIG. 2 is a flow block diagram and shows the reward points system of one embodiment of the present invention.

FIG. 3 is a flow block diagram and shows possible mood color themes to personalize the graphical user interface of one embodiment of the present invention as a call to action.

FIG. 4 is a flow block diagram and shows calendar options of one embodiment of the present invention.

FIG. 5 is a flow block diagram and shows calendar alert receiving options of one embodiment of the present invention.

FIG. 6 is a flow block diagram and shows how to book new travel options of one embodiment of the present invention.

FIG. 7 is a flow block diagram continuing from FIG. 6 and shows how to book new travel options of one embodiment of the present invention.

FIG. 8 is a flow block diagram and shows travel alerts options of one embodiment of the present invention.

FIG. 9 is a flow block diagram continuing from FIG. 8 and shows travel alerts options of one embodiment of the present invention.

FIG. 10 is a flow block diagram and shows general alert options of one embodiment of the present invention.

FIG. 11 is a flow block diagram and shows smart phone applications of one embodiment of the present invention.

FIG. 12 is a flow block diagram and shows the desktop application options of one embodiment of the present invention.

FIG. 13 is a screen shot of one embodiment of a webpage of a website of the present invention.

FIG. 14 is a screen shot of one embodiment of webpage of the present invention and shows how to add a trip.

FIG. 15 is a screen shot of one embodiment of a notification in a social media site in conjunction with the present invention.

FIG. 16 is a screen shot of one embodiment of a webpage and shows a map of a future trip planned by the user.

FIG. 17 is a screen shot of one embodiment of a webpage of the present invention and shows the reminder feature.

FIG. 18 is a screen shot of one embodiment of a webpage of the present invention and shows where a user may enter personal information.

FIG. 19 is a screen shot of one embodiment of a webpage of the present invention and shows a window for inviting others for gifting.

FIG. 20 is a screen shot of one embodiment of a webpage in conjunction with the present invention and shows the webpage for adding a widget.

FIG. 21 is a screen shot of one embodiment of a webpage of the present invention and shows how a user may add a request for travel funds.

FIG. 22 is a screen shot of one embodiment of a notification in a social media site after a request for travel funds has been made by the user.

FIG. 23 is a screen shot of one embodiment of a webpage of the present invention and shows a history of funds that are gifted to other users.

FIG. 24 is a screen shot of one embodiment of a webpage of the present invention and shows how a user can save funds for a trip.

FIG. 25 is a screen shot of one embodiment of webpage of the present invention and shows a confirmation when money has been saved by the user.

FIG. 26 is a screen shot of one embodiment of a webpage of the present invention and shows the webpage where a user may book a trip.

FIG. 27 is a screen shot of one embodiment of a webpage of the present invention and shows how a user may search a hotel.

FIG. 28 is a screen shot of one embodiment of a webpage of the present invention and shows a problem notification to the user regarding booking.

FIG. 29 is a screen shot of one embodiment of a webpage of the present invention and shows a confirmation page when booking the flight.

FIG. 30 is a screen shot of one embodiment of a booking notification to a social media site in conjunction with the present invention.

FIG. 31 is a screen shot of another embodiment of a notification in a social media site of the present invention.

FIG. 32 is a screen shot of one embodiment of a website of the present invention and shows how users can send travel funds to their social media, non-social media, and socially integrated friends.

FIG. 33 is a screen shot of another embodiment of a notification in a social media website in conjunction with the present invention and shows the notification after a gift has been sent by the user.

FIG. 34 is a screen shot of one embodiment of a notification in a social media website in conjunction with the present invention and shows a comment field where a user may provide comments or messages.

FIG. 35 is a screen shot of one embodiment of webpage in conjunction with the present invention and shows travel options based upon a set saved funds.

FIG. 36 is a screen shot of one embodiment of a webpage of the invention and shows the travel options to the user.

FIG. 37 is a screen shot of one embodiment of a webpage of the invention and shows the finalization webpage when booking a trip.

FIG. 38 is a screen shot of one embodiment of a webpage of the invention and shows how a user may add funds.

FIG. 39 is a screen shot of one embodiment of a webpage of an online money transfer website of the invention.

FIG. 40 is a screen shot of one embodiment of a webpage of an online money transfer website of the invention and shows a notification after funds are transferred.

FIG. 41 is a screen shot of one embodiment of the invention and shows how a user may create a wish list.

FIG. 42 is a screen shot of one embodiment of a webpage of the invention and shows information after a user selects the monitor friends button.

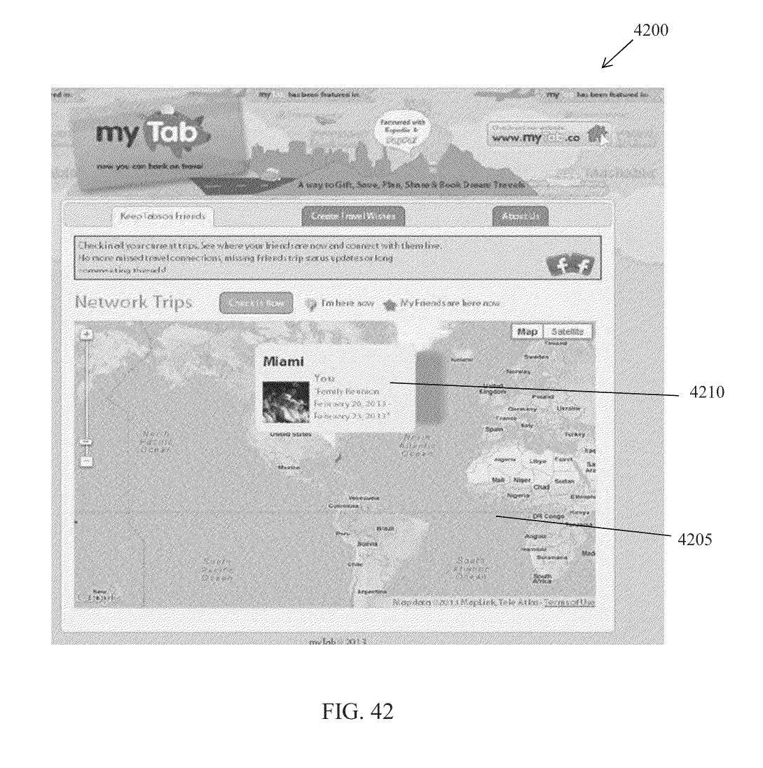

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “computer” refers to any device that processes information with an integrated circuit chip, including without limitation, mainframe computers, work stations, servers, desktop computers, portable computers, laptop computers, embedded computers, wireless devices including cellular phones, personal digital assistants, and portable game players, and hand-held computers; “internet” refers to any collection of networks using standard protocols, whether Ethernet, ATM, FDDI, Wi-Fi, Token ring, or any combination thereof; and “website” refers to any document written in a mark-up language including, but not limited to, HTML (hypertext mark-up language) or VRML (virtual reality modeling language), dynamic HTML, XML (extended mark-up language), WML, or any other computer languages related thereto, as well as to any collection of such documents reachable through one specific Internet Protocol Address or at one specific World Wide Web site, or any document obtainable through any particular URL (Uniform Resource Locator); and “web page” (or “page”) refers to any of the various documents and resources on the World Wide Web, in HTML/XHTML format with hypertext links to enable navigation from one page or section to another, or similar such resources used on the internet. The term “social media” refers to media that is designed to be disseminated through social interaction, preferably using accessible and scalable publishing techniques. Social media is typically a website where members load profiles and meet and interact in various manners with other members.

The method of the present invention requires a user to use a computer or smart phone to access most of the functions of the full service travel website and designated savings account or gift card.

The system for managing travel of the present invention is preferably called TABT™, which stands for Travel Account Bank. The present invention generally includes a saving platform for individuals and/or businesses to manage funds in order to book future travel. The travel is preferably accessed at a specific designated website. The website provides a graphical user interface with which the user accesses, via a computer, the features of the present invention.

The travel website and system of the present invention is preferably linked to a designated savings account or gift card. The funds of the account are placed in the account by the user, or other third parties, for the express purpose of being spent on travel. More specifically, to be used to purchase travel through the travel website and system of the present invention. The designated savings account or gift card is preferably an online account, such as a PayPal® money market account. However, any type of online or bank account may be used, so long as the account can be accessed by the user, have funds added via an online portal, and so long as the account or gift card can be linked to the travel website and system of the present invention.

Preferably the account or gift card generates interest (monthly, annually, etc.). The user can elect to have the interest roll into the account or gift card or be used for another purpose, such as donating to a charity or donating to offset the carbon footprint of the user's travel plans.

The travel website and system of the present invention may include a calendar of options to alert the user, and possibly other members, as approved by the user and allowed by the system, of numerous, customized travel related planning the user has requested to receive.

The calendar alerts preferably provide users with early-bird purchase options, including ecologically friendly purchase options, which may take into account the existing funds in the account or gift card, along with a multitude of additional features including group travel correspondence and budgetary notifications.

Non-registered members of the travel website and system may use the system, but they do not get the benefit of the exclusive deal or the rewards points.

Preferably the present invention includes an application that allows the invention to be accessed or controlled through a smart phone application. Although these smart phone applications typically have a narrower set of features.

The travel website and system of the present invention also may provide the option for members to donate at a regular basis to various ecologically friendly charities.

The travel website and system of the present invention may generate revenue from online booking commissions, as is well known in the art of travel websites.

The travel website and system of the present invention may provide a notification mechanism for other travel users. For example, for group accounts, once a trip is booked by one individual in the group, other group travelers may be notified by the computer-based method of the individual's travel purchase in order to allow the rest of the group to book the same travel. Another example is social media sites, which preferably notify friends of other users that a trip is booked on any social media plug-in such as Facebook® and Twitter®.

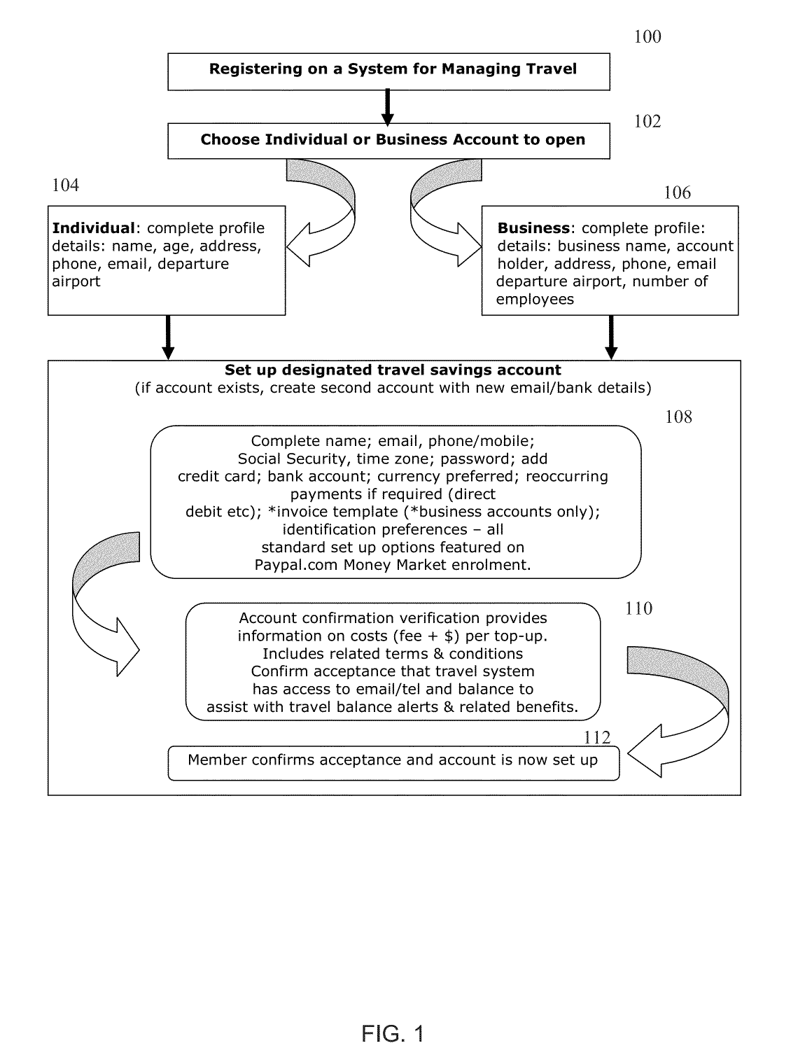

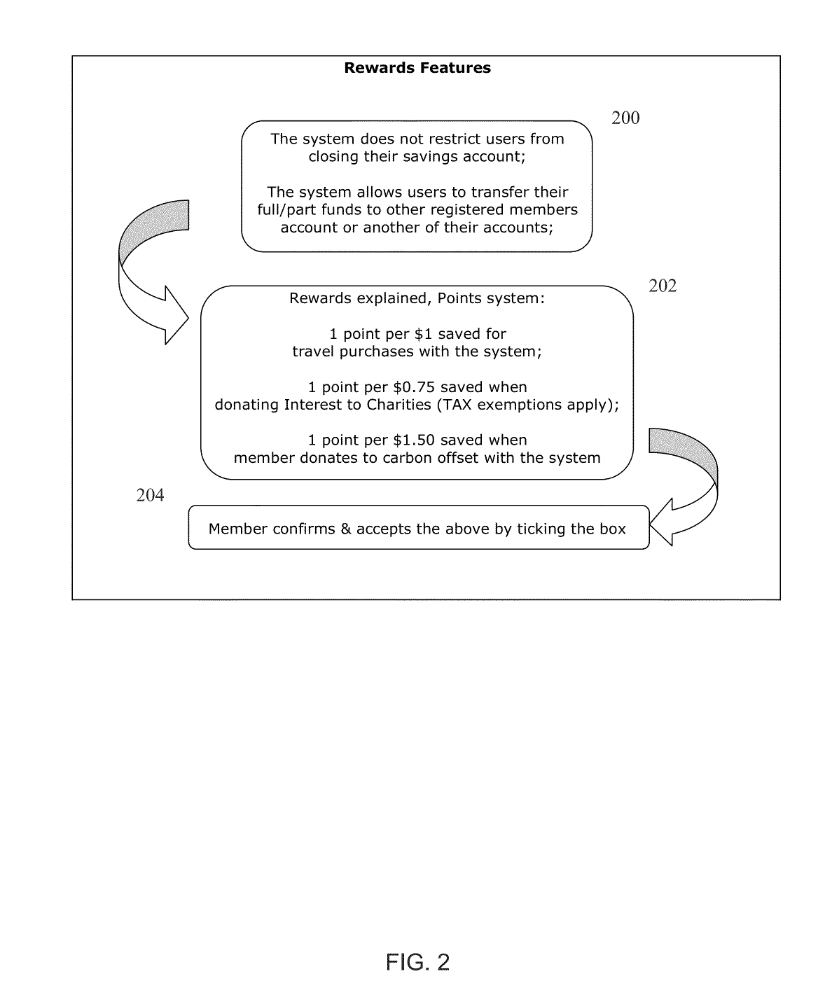

FIG. 1 is a flow block diagram and shows the initial registration steps of one embodiment of the present invention. As shown in FIG. 1, a user first registers as a member on a system for managing travel 100. The user accesses the system via computer or smart phone. The user opens a business or an individual account 102. If the user is an individual, she inputs profile details, including name, age, address, phone, email, and local departure airport 104. If the user is a business, it provides, name, account holders, address, phone, email, departure airports, and number of employees 106. The next step of the method is to provide, or otherwise set up and designate a travel savings account or gift card. The user provides information for the account, including name, email, phones, travel goal amount, time zones, usernames, passwords, account number, currency in which transactions will be performed, reoccurring payments or withdrawals, invoice templates, identification preferences, and any other options that are standard features of savings accounts 108. The account information set up and verification preferably includes accepting terms and conditions, including any fees associated with the account or gift card, linking the savings account to travel system, and acceptance that the travel system has access to all of the account information 110. Once the member confirms acceptance, the account is set up 112 and the user can input calendar information and personalize the system interface. The set up of the system is continued on FIG. 2.

FIG. 2 is a flow block diagram and shows the reward points system of one embodiment of the present invention. As shown in FIG. 2, although the funds in the designated savings account or gift card are preferably only spent on travel, the system will not necessarily restrict users from closing the savings account or use the funds for other purchases Additionally, within the invention, the user can also transfer their funds into any other registered members' accounts 200. FIG. 2 also shows the preferred reward points system 202. The user gains one (1) reward point for every dollar saved in the designated savings account or gift card, and/or used for travel purchases with the travel system. One (1) reward point for each $0.75 that is donated to a charity, preferably an ecologically friendly charity. Additionally, one (1) reward point is gained for every $1.50 that is donated to offset the users travel carbon footprint. It should be understood that reward points may also be granted for many other activities, including purchasing travel insurance from the travel system. Furthermore, the reward point system may also change for each dollar that is saved, gifted, and/or redeemed.

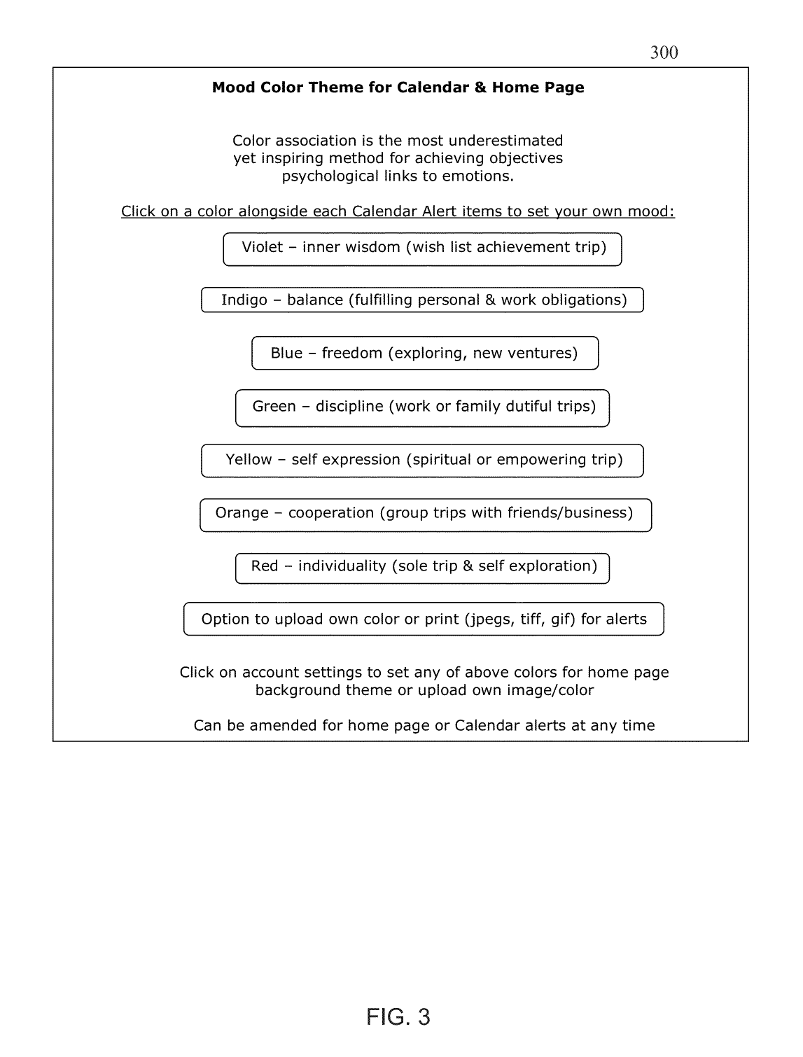

FIG. 3 is a flow block diagram and shows possible mood color themes to personalize the graphical user interface of one embodiment of the present invention as a call to action. As shown in FIG. 3, the user preferably personalizes her graphical user interface with the system. This personalization includes associating colors with each calendar alert item 300. The colors include, but are not limited to Violet, Indigo, Blue, Green, Yellow, Orange, or Red. Each of these colors, as shown in FIG. 3, relates to a mood or have special meeting. The user may also upload her own custom colors. The events associated with the colors may be amended at any time by the user.

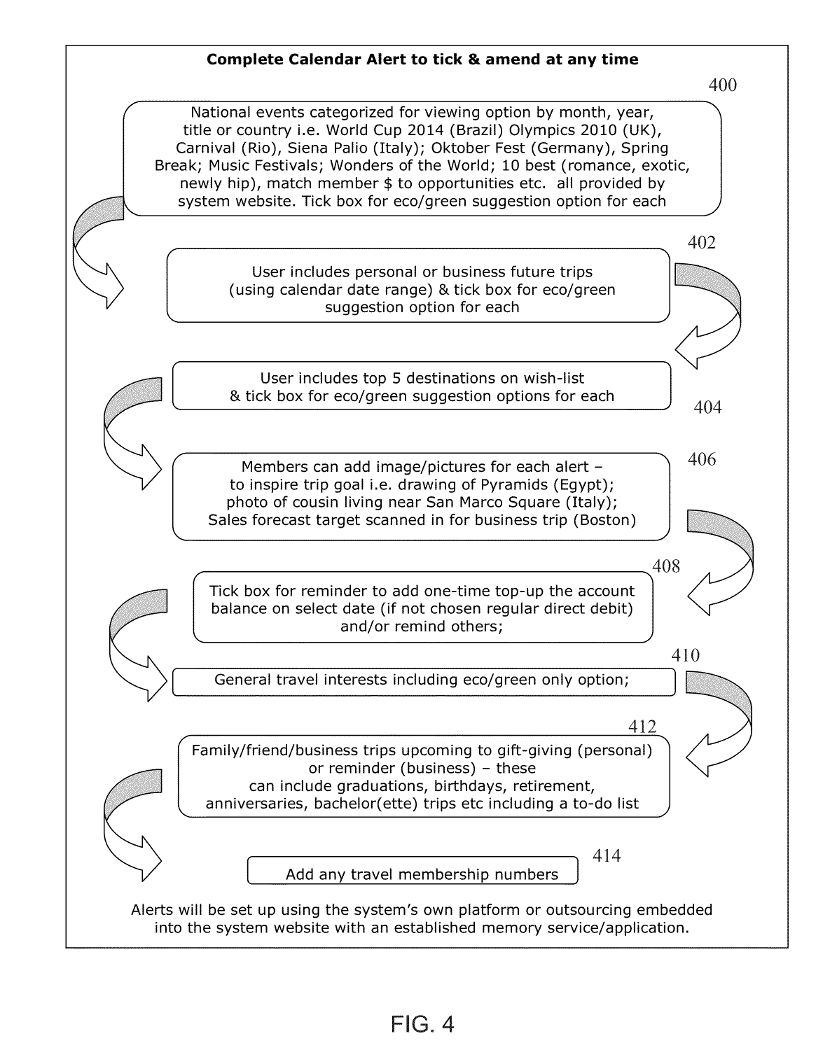

FIG. 4 is a flow block diagram and shows calendar options of one embodiment of the present invention. FIG. 4 continues to detail the set up of the travel system. The user is able to calendar many types of events, including large international or national events, such as the World Cup 400. If preferred, the user can set up an additional option of having green travel suggestions as part of any event calendar entry. The events calendared are typically suggested to the user by the system, or generated by the user. User generated events include personal or business future trips 402. The user also preferably selects a wish list with those people's top five destinations 404. The calendared events are preferably personalized, where the member can add images or pictures for each alert 406. The user can also set a reminder to add to the savings account at select dates 408. This can reminder can be sent to other users or friends and family. This reminder system is especially useful if the user does not have a reoccurring deposit into the account from a regular paycheck, another account, or gift card. The user may calendar her general travel interests, including whether she wants to travel using green options only 410. The user can also calendar her friends and family's gift-giving dates, such as graduations, anniversaries, retirements, and birthdays 412. The user may also add travel membership numbers 414. Finally, the calendar alerts may be set up using the system's own platform or calendar, or it may be imported into the system through the system website with an established memory service or application.

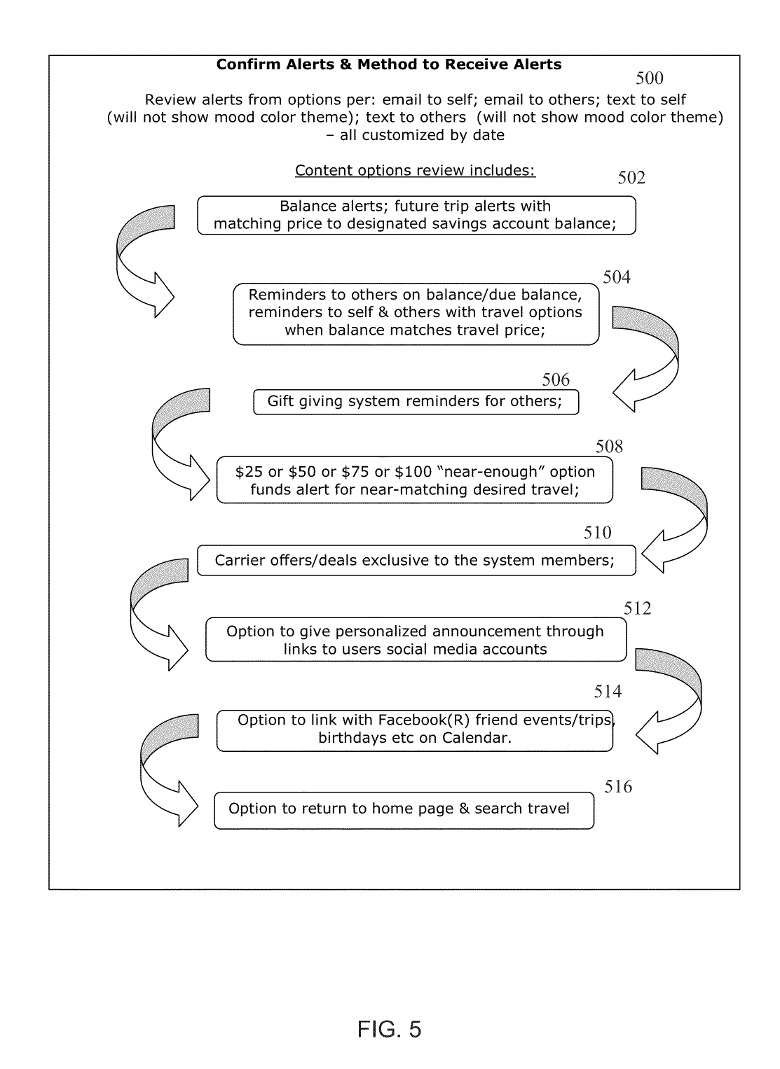

FIG. 5 is a flow block diagram and shows calendar alert receiving options of one embodiment of the present invention. FIG. 5 shows how the user determines how the alerts are sent, such as email to self, email to others, text to self, or text to others 500. Any alert sending system may be used. The alerts are preferably confirmed and reviewed by the user. The contents of the alert are preferably determined. The alert may include account or gift card balance information 502. The alerts sent to others may disclose the current balance, a needed amount to complete a goal, or the current travel options now that a current balance has been reached 504. The calendar system allows the user to set gift giving reminders for others 506. Preferably the calendar alert function has a “near-enough” “Match myCash” option for when the amount in the account is almost at a level that will allow for travel goal to be met 508 or meets the requirements for “Match myCash”. The calendar alert function allows a user to request offers and reminder about carrier offers and exclusive member deals 510. The user may also sign up to get personalized announcements through social media accounts, such as Facebook® 512. The user may also use the calendar alert function to send announcements to others through social media sites 514. Once the user has set all of her alerts, she has the option to return to the homepage of the travel system website or go to the search page 516.

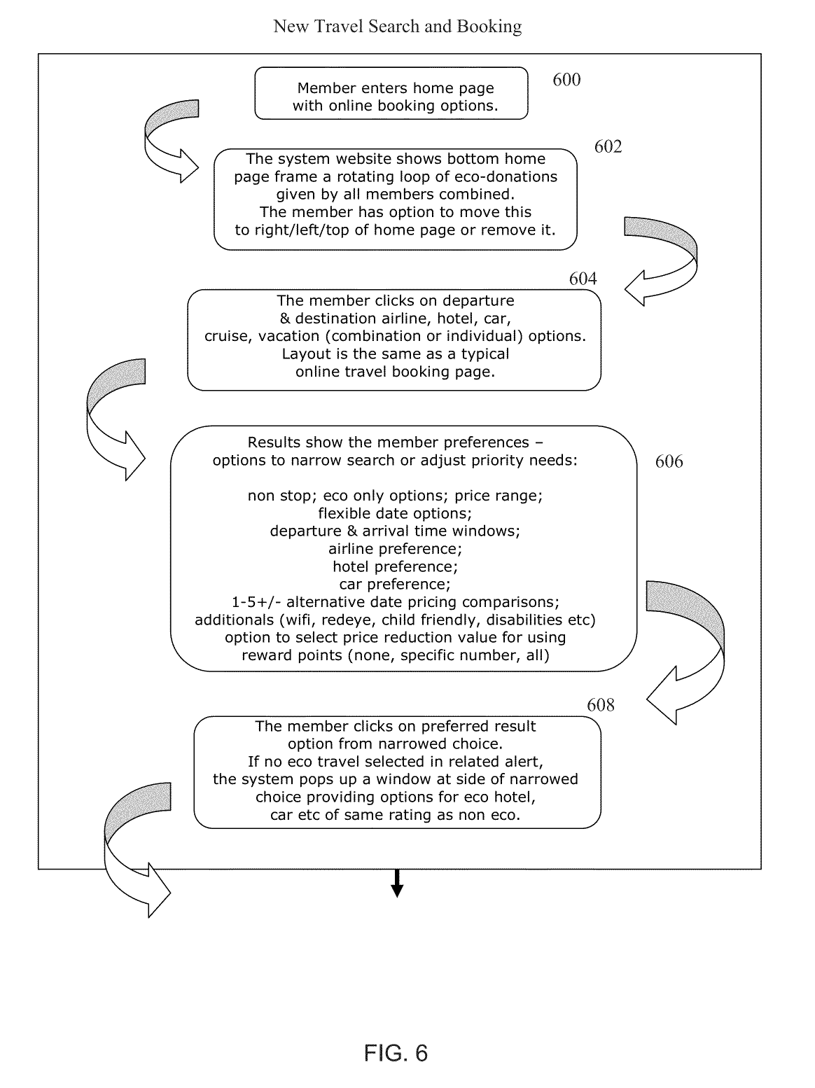

FIG. 6 is a flow block diagram and shows how to book new travel options of one embodiment of the present invention. After the user has set up and calendared alerts, the preferred next step of the present invention is to book travel arrangements. The member accesses the travel system website by signing in at the home page 600. The home page allows members to look up travel options. Preferably the homepage has a rotating loop banner of eco-donations given by members 602. This banner may be removed or moved to any location of the homepage. Similar to other full service travel websites, the members are provided with a plurality of travel options which are selected by the member. The member may click on departure and destination airports, select an airline, hotel, car, cruise, or other travel or vacation option 604. The homepage will preferably reflect each individual's preferences and has other options to narrow the member's search or otherwise adjust to the priorities or needs of the member 606. These preferences may include non-stop, ecologically friendly only options, price ranges, flexible date options, departure and arrival time windows, airline preferences, hotel preferences, rental car preferences, alternative date pricing comparisons, Wi-Fi availability, redeye flight, pet friendly, child friendly, disability accessible, and the ability to use reward points to reduce the price of the option 606 for exclusive and non-exclusive travel. The member clicks on the preferred options from the narrowed choices 608. If the user does not select any of the environmentally or ecologically friendly options, the system preferably has a pop-up website window that details the eco-friendly options that are comparable to the option selected. The steps for booking are continued in FIG. 6.

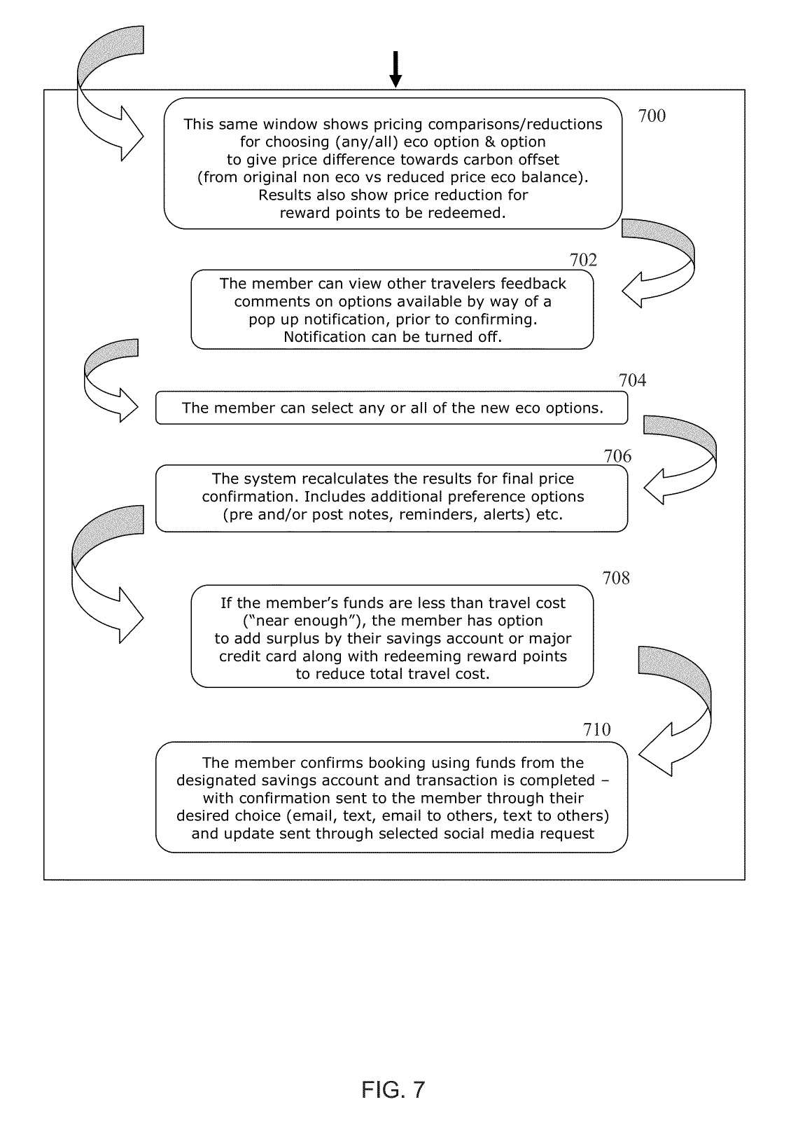

FIG. 7 is a flow block diagram continuing from FIG. 6 and shows how to book new travel options of one embodiment of the present invention. The same pop-up website window of 608 preferably shows pricing comparisons for choosing the eco-friendly option and how much would need to be spent towards a carbon offset for choosing the non-eco-friendly option 700. The website also allows the member to view comments and feedback by other members who have selected the same options 702. This option may be turned off if desired. Once the eco-friendly option pops-up, the user may change to the eco-friendly option by clicking on it 704. The system would then recalculate the final price 706. If the member does not have enough funds in the designated savings account or gift card the user can transfer funds into the account using an online payment option to replenish the designated savings account, a credit card, or possibly rewards points 708. The member confirms the booking and pays for the travel with funds from the designated savings account 710. A confirmation is sent to a member via the desired method, such as email, text, or social media 710.

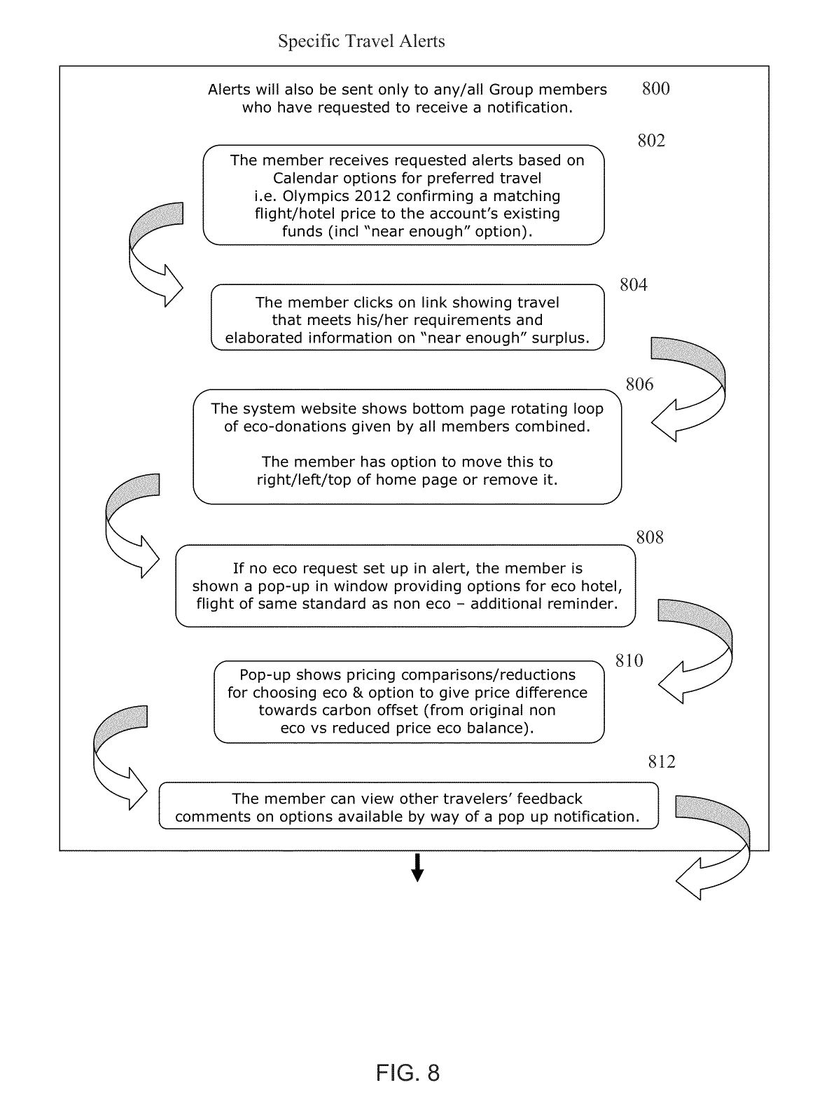

FIG. 8 is a flow block diagram and shows travel alerts options of one embodiment of the present invention. The user is able to set up specific alerts and reminders based on the specific travel booked. These alerts may also be sent to any groups of other members who have been requested to receive the alerts 800. The user may receive an alert based on a desired calendar option 802. The member may click on the link showing travel that meets her requirements and other payment information 804. As discussed previously, the system also may show the eco-friendly donations by members 806. If the user has not set up any eco-friendly alerts, the user is shown in a pop-up window the eco-friendly options that were not shown, or not selected 808. This option promotes eco-friendly options. The pop-up shows the price comparison and how much would need to be donated to a carbon offset if the non-eco-friendly option is selected 810. It is hoped that the user goes back to select the eco-friendly option once she sees how much better for the environment the eco-friendly option is. The member may also view other user's feedback and comments on the options that are displayed 812.

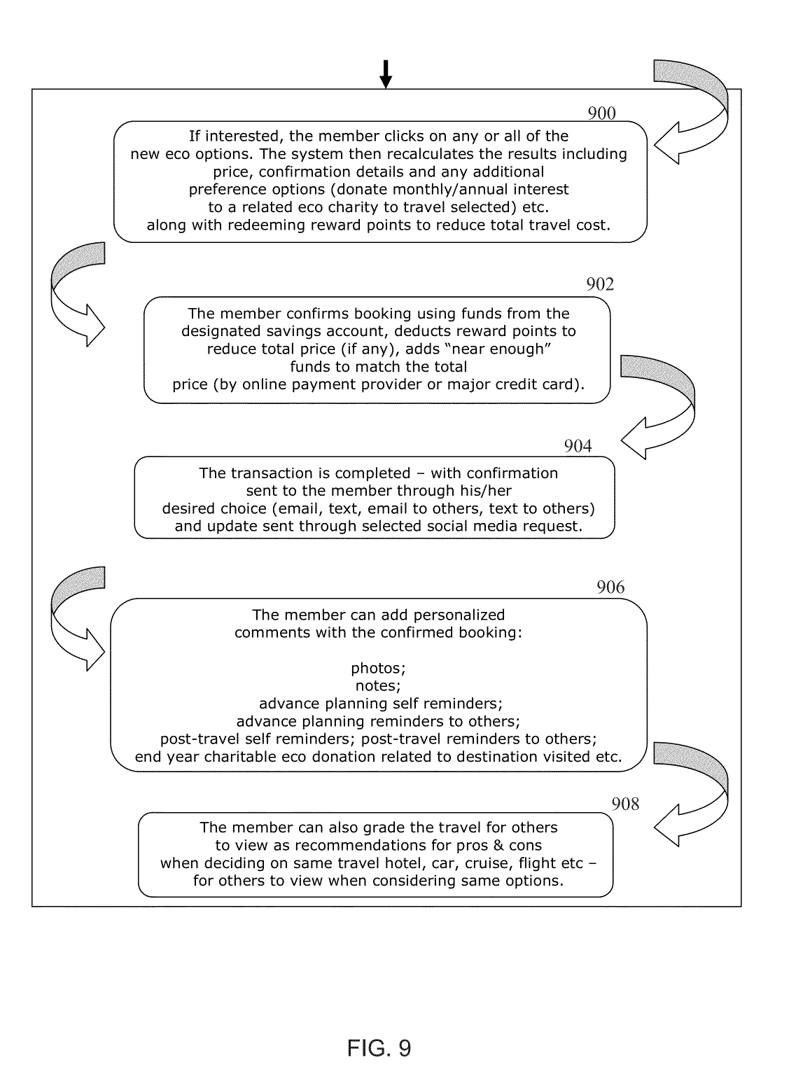

FIG. 9 is a flow block diagram continuing from FIG. 8 and shows travel alerts options of one embodiment of the present invention. FIG. 9 shows that if the member is interested, she may click on any or all of the new eco-friendly options 900. The system recalculates the price based on the new options and confirms the new details and other options related to choosing the eco-friendly option. The system also allows reward points to be redeemed, which may not have been redeemable before selecting the eco-friendly option. The user confirms the booking by paying with funds in the designated savings account 902. Once the transaction is completed the user and any other designated third parties receive a confirmation via one or more selected means, such as email or text 904. The rewards points are preferably taken into consideration along with any additional funds that may be needed if the designated travel savings account or gift card does not have enough funds. The member can add personalized comments to the confirmed booking, such as photos, notes, advanced planning self reminders, advanced planning reminders to others, post travel self reminders, post travel reminders to others, and reminders to donate to an eco-friendly charity to offset the carbon footprint generated by the travel 906. Finally, the member can comment, grade, or otherwise provide feedback on the selected travel option for other members to review 908.

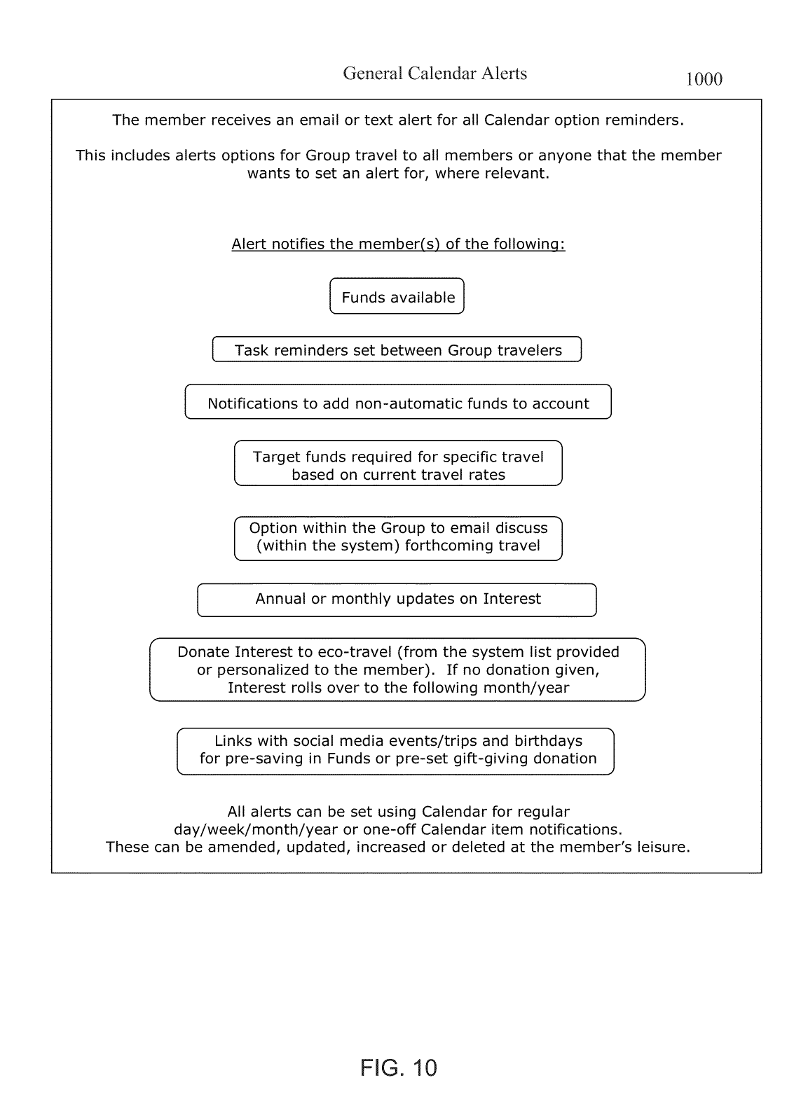

FIG. 10 is a flow block diagram and shows general alert options of one embodiment of the present invention. Preferably the member receives general calendar alerts 1000. The member and or third parties receive an email or text alert of the selected calendar alert reminders. The alert may be sent a designated group. The alert may include, but is not limited to the following: funds available; group task reminders; notifications to add funds to the designated savings account or gift card; the amount of funds needed for specific travel (based on current travel rates); group discussion reminders; interest accrued; donation related reminders; reminders to link with social media sites for special events, such as birthdays or preplanned trips. The alerts can be amended, updated, or deleted via the travel website of the present invention.

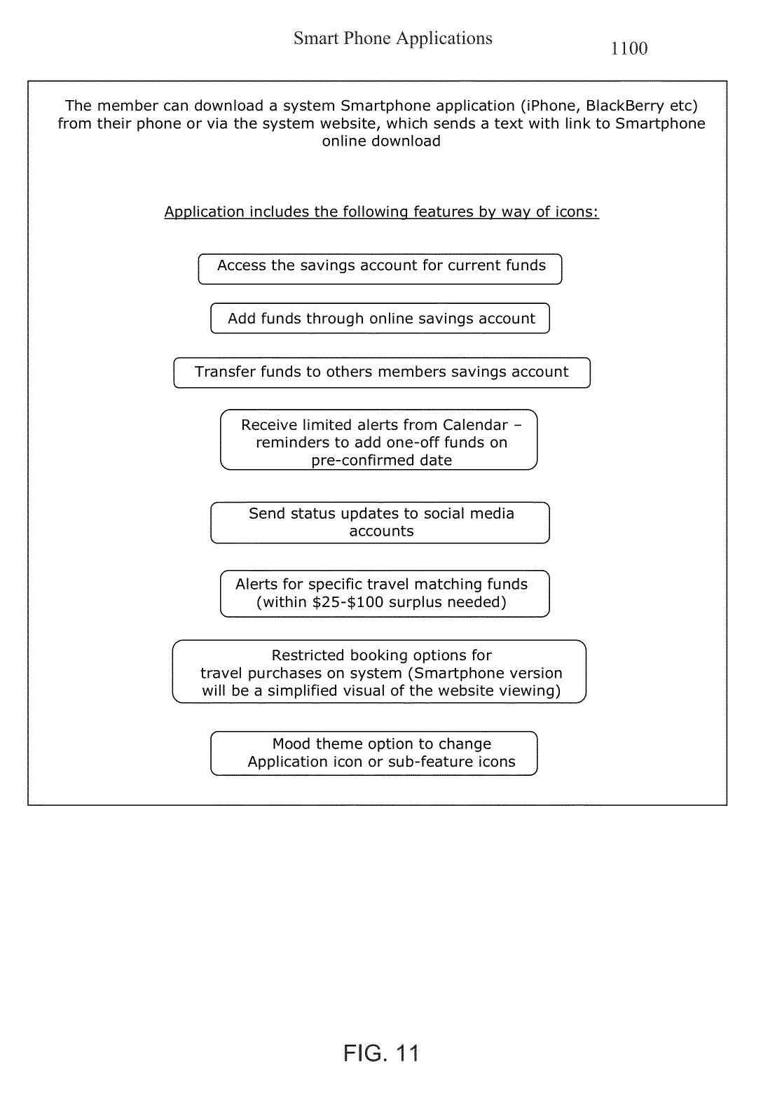

FIG. 11 is a flow block diagram and shows smart phone applications of one embodiment of the present invention. Rather than accessing the system through a computer, the user may access the travel system through a smart phone, tablet, or related consumer electronic devices 1100. This typically requires the user to download an application enabling the user to use the smart phone to access the system. The application may be downloaded via the phone or via the travel website. Preferably the smart phone application includes the following features, which are accessible through an icon: access to the designated savings account or gift card to view current funds available; the ability to add funds to the designated savings account or gift card; the ability to transfer funds to other members savings accounts; receive alerts form the calendar alert function, send status updates to social media sites; matching funds alerts; limited booking options; manual and automatic geographical locations (geoloco); check-ins through the trip to enable like-minded demographics and socioeconomics to use this as a travel recommendation tool as a visual trip schedule planner on the smartphone application, invention website and all consumer electronic devices; and the ability to personalize.

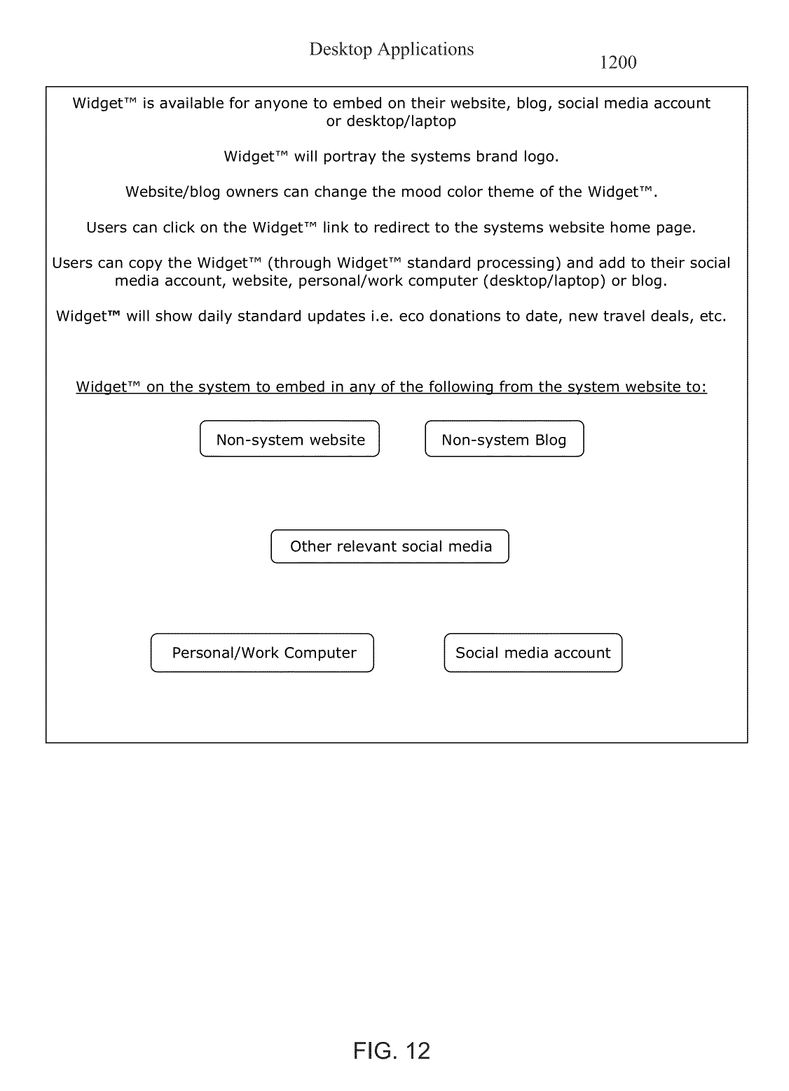

FIG. 12 is a flow block diagram and shows the desktop application options of one embodiment of the present invention. The system, much like a social media site, may be incorporated as links on other websites and desktops through the use of desktop applications, such as Widget™ 1200. Desktop Applications are available for anyone to embed on their website, blog, social media account, or computer desktop. Typically the Widget™ will portray a trademarked logo of the travel system. A widget is also the generic name of the actual link icon that displays the trademarked logo of the system to which it is connected. A widget for the present invention is preferably placed on other non-system websites, blogs, and other relevant social media sites and accounts. The strategic placement of widgets allows members and non-members to connect to the travel system and website. The desktop widget application will preferably show daily updates, such as new deals, donations to charities to date, and a link to the user's invention dedicated page to receive travel cash gifting without the gifter required to sign into the invention website or smartphone application.

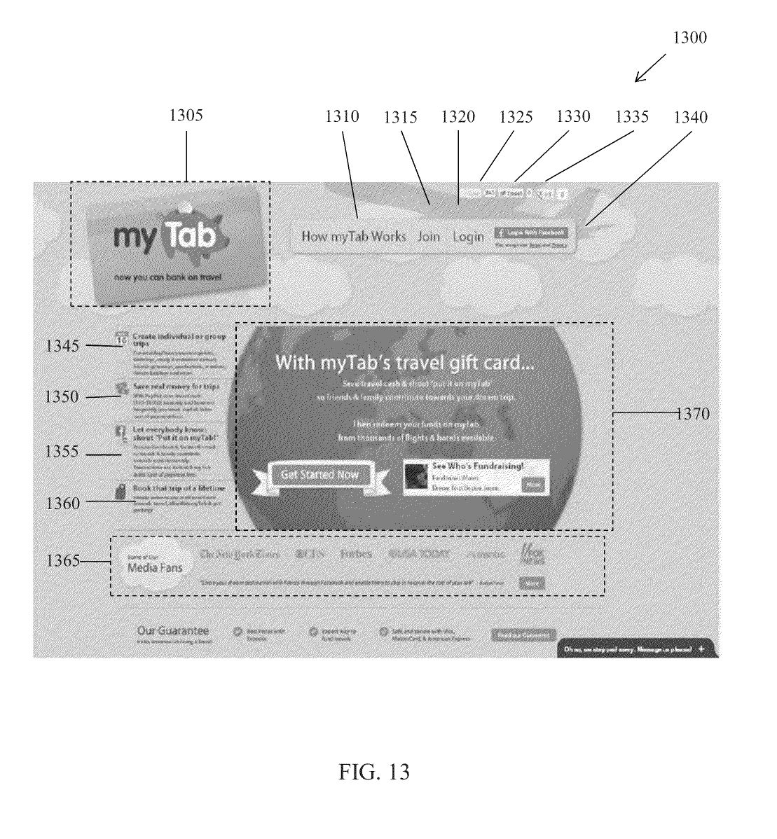

FIG. 13 is a screen shot of one embodiment of a webpage of a website of the present invention. As shown in FIG. 13, the homepage 1300 preferably includes: a logo 1305; general help page 1310; join link 1315; login tab 1320; social media link 1340; group button 1345; saving money link 1350; social media account link 1355; book trip link 1360; sponsor logos 1365; and introductory tutorials and information 1370. The home page 1300 is preferably the home page where a user may login his or her credential in the homepage. A logo 1305 is preferably used to identify the company and page. A tutorial and general help page 1310 is generally used to link to the home page, which preferably allows a user to better understand how to use the website. The user may create an account by selecting the join link 1315 and then access their personal settings by logging in the login tab 1320. Alternatively, a user may login their account by accessing external websites information, such as selecting the social media link 1340. The user may create individual or group trips by selecting the group button 1345, which generally allows others join and/or to see the user's plans. Money may be transferred or saved, and the user may also transfer money or save money by selecting the saving money link 1350 to place towards a trip. The user may also inform others about his or her trip by posting it to their social media account by selecting the social media account link 1355. The user may also choose to search for trips and book trips by selecting the book trip links 1360. Users may also be shown what various entities support or are fans of the website due to the sponsor logos 1365. Further, introductory tutorials and information 1370 may be used to provide information about the system for managing travel.

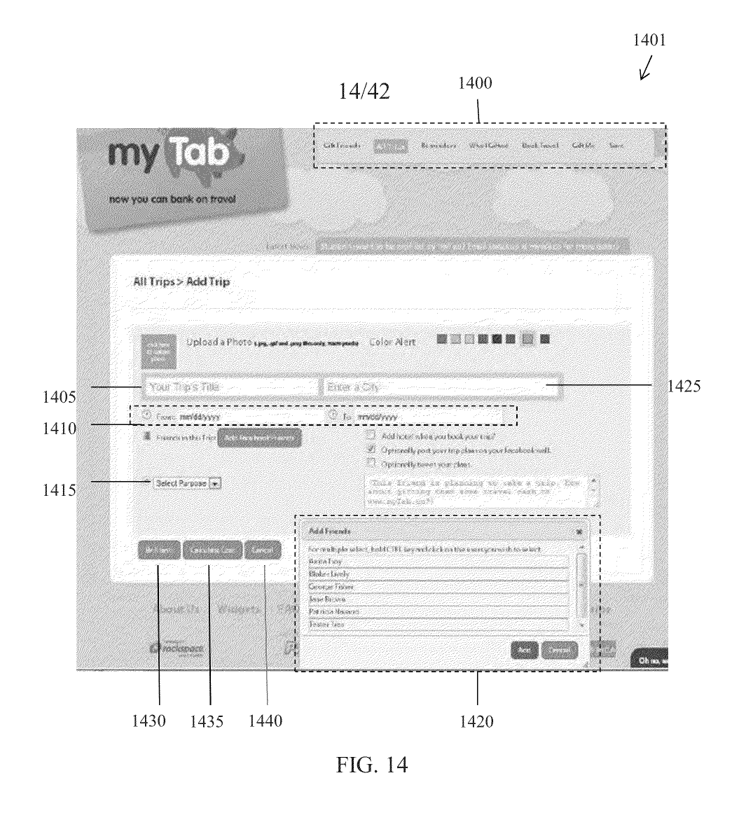

FIG. 14 is a screen shot of one embodiment of webpage of the present invention and shows how to add a trip. As shown in FIG. 14, the webpage for adding a trip 1401 preferably includes: one or more links 1400; name input field for the trip 1405; scroll down menu for dates 1410; scroll down menu for purpose of the trip 1415; friend input fields 1420; location input field 1425; user information button 1430; cost button 1435; and cancel button 1440. The one or more links 1400 typically allows the user to navigate to other parts of the website. The name input field for the trip 1405 allows the user to create and name a trip. The friend input fields 1420 preferably allows the user add friends from social media sites and inform the friends about the trip or possibly invite their friends regarding the trip. The scroll down menu for dates 1410 preferably allows the user to select days and times, on which the user may want to go on a trip. The location input field 1425 preferably allows the user to designate the type of trip the user desires such as trips for business or pleasure. The user information button 1430 generally allows the user to input information about himself or herself.

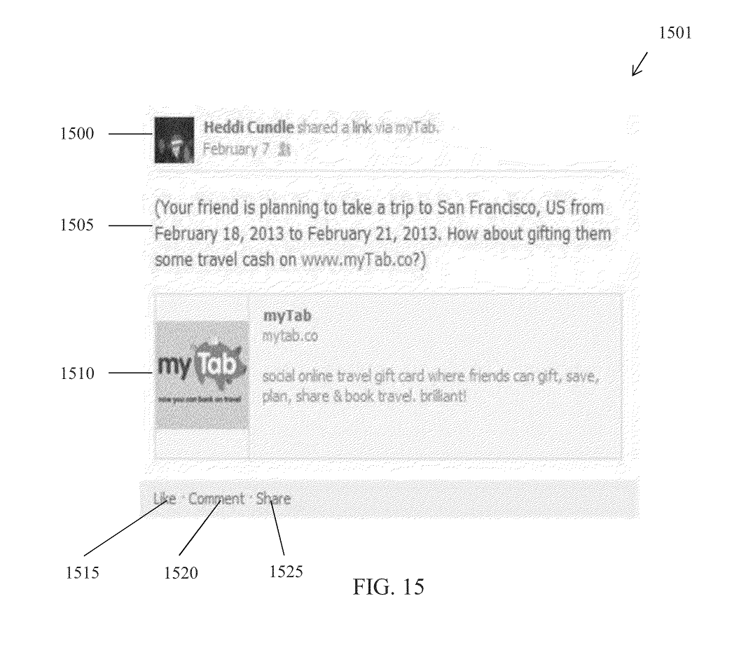

FIG. 15 is a screen shot of one embodiment of a notification in a social media site in conjunction with the present invention. As shown in FIG. 15, the notification 1501 preferably includes: member information 1500; trip information 1505; travel website information (or advertisement) 1510; like button 1515; comment button 1520; and share button 1525. The member information 1500 generally provides user information corresponding to a particular social media site such as the user's name and photo. The trip information 1505 typically provides information regarding the trip such as date, time, and location. The travel website information 1510 preferably provides contact information as to the website of the present invention. The like button 1515 preferably allows other members of the social media site to show interest towards a particular trip of the user. The comment button 1520 generally provides other members of the social media site to provide comments regarding the trip. The share button 1525 preferably provides other members of the social media site with the opportunity to share information regarding the trip to other websites, including the newsfeed of other social media sites.

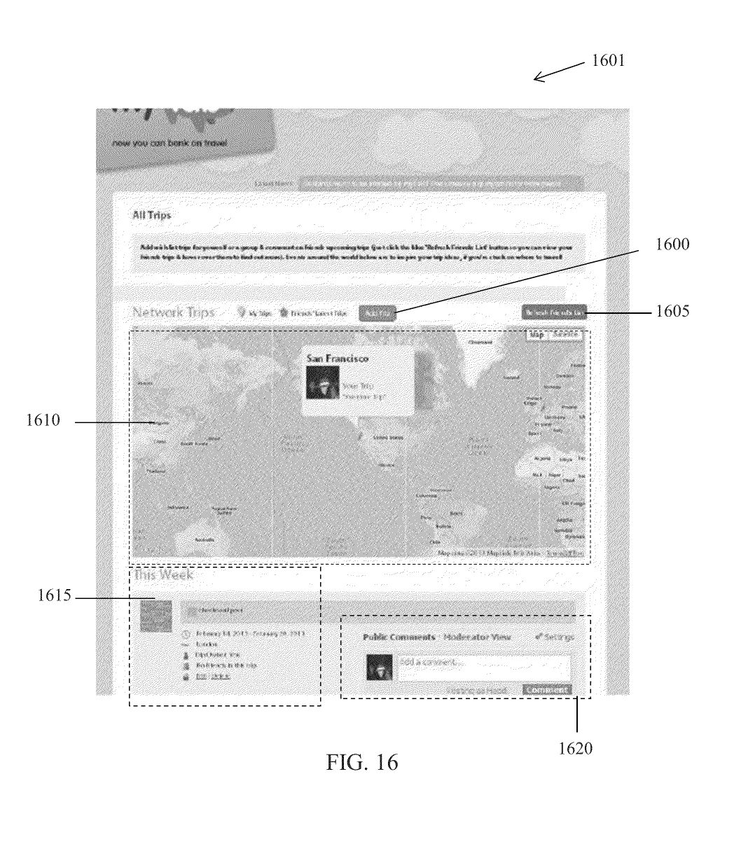

FIG. 16 is a screen shot of one embodiment of a webpage and shows a map of a future trip planned by the user. As shown in FIG. 16, the webpage 1601 preferably includes: an add trip button 1600; a refresh button 1605; a map 1610; information for upcoming events 1615; and a comment section 1620. The add trip button 1600 preferably allows the user to add one or more trips to his or her account. The refresh button 1605 preferably allows a user to update the webpage and receive new information concerning their friends from the social media sites. The map 1610 preferably shows the locations of various members of social media sites, their trip plans, and the user's own location and trip plans. The information for upcoming events 1615 preferably shows upcoming trips of the user and other members of the social media site. The commenting section 1620 preferably allows the user or others to make comments on the webpage, preferably through the use of social media websites.

FIG. 16 also shows that users may see their own future wish list trips and their friend's future trips. Users preferably can comment on the trips within the commenting section per trip, which may be posted in various social media websites. Users and friends may create multiple trips, and hover a mouse pointer over an icon on the map preferably shows all the trips the user and their friends are planning.

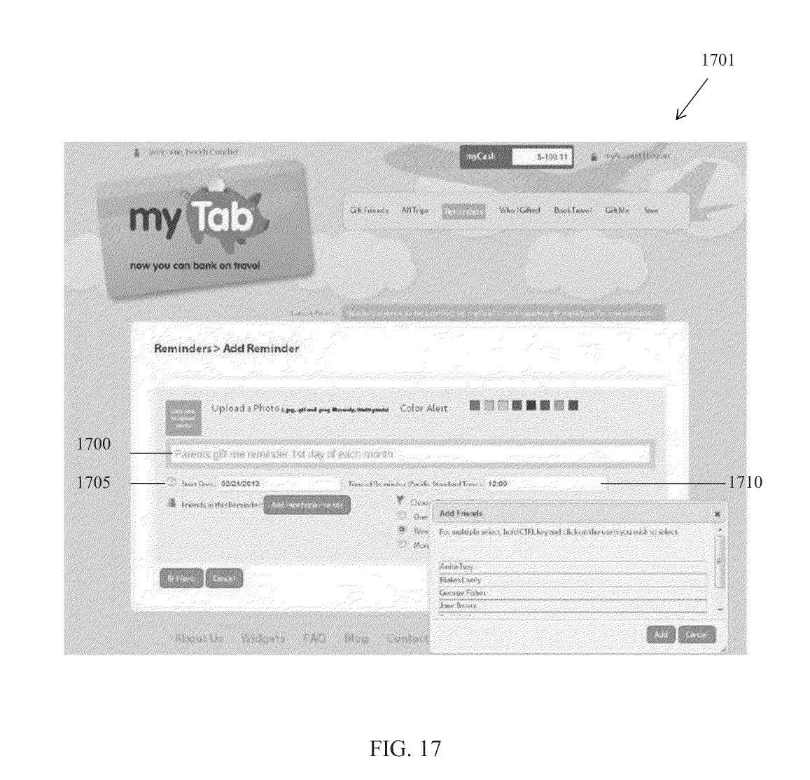

FIG. 17 is a screen shot of one embodiment of a webpage of the present invention and shows the reminder feature. As shown in FIG. 17, the reminder feature 1701 preferably includes: a text entry area 1700; a date selection area 1705; and a time selection area 1710. The text entry area 1700 preferably allows a user to enter a reminder or message about a certain event. The date selection area 1705 preferably allows the user to select a date as to when the message should be brought to the user's attention. The time selection area 1710 preferably allows the user to select a time of the day selected in the date selection area 1705 for the message to be brought to the user's attention.

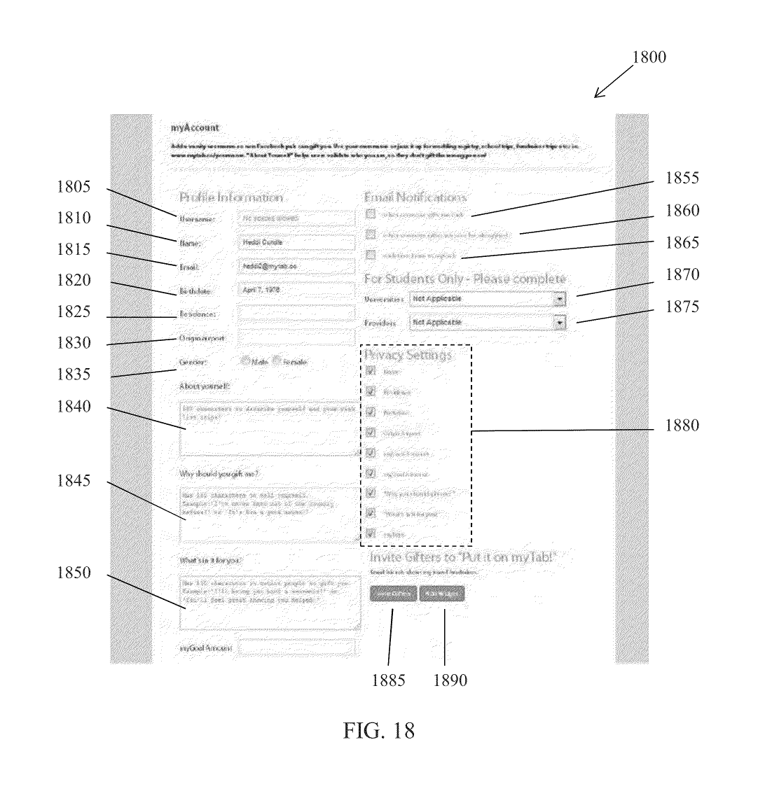

FIG. 18 is a screen shot of one embodiment of a webpage of the present invention and shows where a user may enter personal information. As shown in FIG. 18, the webpage 1800 preferably includes: a username input field 1805; a name input field 1810; an email input field 1815; a birthdate input field 1820; a residence input field 1825; an origin input field 1830; gender select buttons 1835; comment fields 1840, 1845, 1850; an email updates check box 1855; check box for receiving notifications 1860; check box for email updates 1865; a university selection drop down menu 1870; drop down menu for student providers 1875; privacy selection check boxes 1880; an invitation to gift button 1885; and an add widgets button 1890. The username input field 1805 preferably allows a user to select or create a username by which they are associated with. The name input field 1810 preferably allows the user to input their name. The email input field 1815 preferably allows the user to create or input an email address, from which the user may receive information regarding the website. The birthdate input field 1820 preferably allows the user to input their date of birth. The residence input field 1825 preferably allows the user to input the location of their residence, which may assist in determining available flights. The origin input field 1830 preferably allows the user to input the location from which they will travel from. The gender select buttons 1835 preferably allows the user to select his or her gender. Input field 1840 preferably allows the user to input information regarding himself or herself, including without limitation, the user's likes, interests, qualities, and experiences. Input field 1845 preferably allows the user to write one or more reasons as to why a friend or family member should assist the user with providing funds for the trip. Input field 1850 preferably allows the user to explain what items a person will receive if that person provides a gift to the user. The email updates check box 1855 preferably allows users to indicate whether they would like updates to be sent to their email address. The check box for receiving notifications 1860 preferably allows the user to receive an email when they are gifted by another user. The check box for email updates 1865 preferably allows users to indicate that they would like to have an email notification sent to them when funds are added to their gift card. The university selection drop down menu 1870 preferably allows the user to indicate if they are attending a university or institution. The drop down menu for student providers 1875 preferably allows users to indicate who their providers are. The privacy selection check boxes 1880 preferably allow a user to as to what information is visible to other users. The invitation to gift button 1885 preferably allows the user to request that other users gift them funds to their gift card through various social and non-social means. The add widgets button 1890 preferably allows the user to add or create a widget which invites other users to gift funds to the user's gift card.

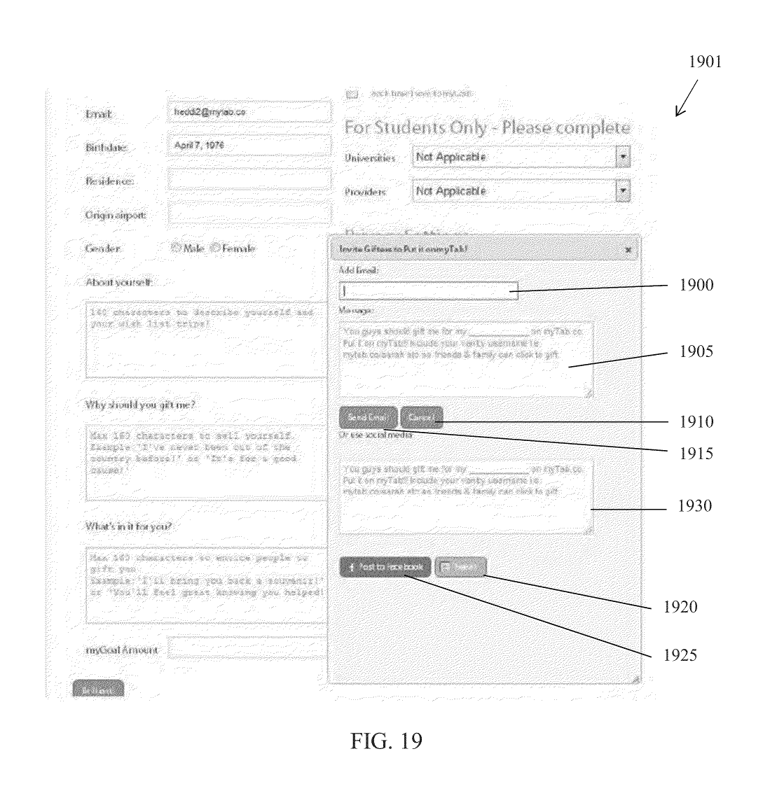

FIG. 19 is a screen shot of one embodiment of a webpage of the present invention and shows a window for inviting others for gifting. As shown in FIG. 19, the webpage 1901 preferably includes: an email input field 1900; an email message input field 1905; a send email button 1915; a cancel button 1910; a social media message input field 1930; and social media buttons 1920, 1925. The email input field 1900, allows a user to select an email address to send a request for a gift message. The email message input field 1905 typically allows a user to input text to send in an email. The send email button 1915 generally allows a user to send the message located in the email message input field 1905 as an email. The cancel button 1910 preferably allows a user to cancel and delete the information from the email input field 1900 and email message input field 1905. The social media message input field 1930 preferably allows a user to input a message which may then be posted via the social media sites. The social media buttons 1925, 1920 allows a user to post the message inputted into the social media websites such as Facebook® and Twitter®. Users may email an individual or multiple friends to provide them with travel funds for their trips. They may also post their request for travel cash to various social media websites.

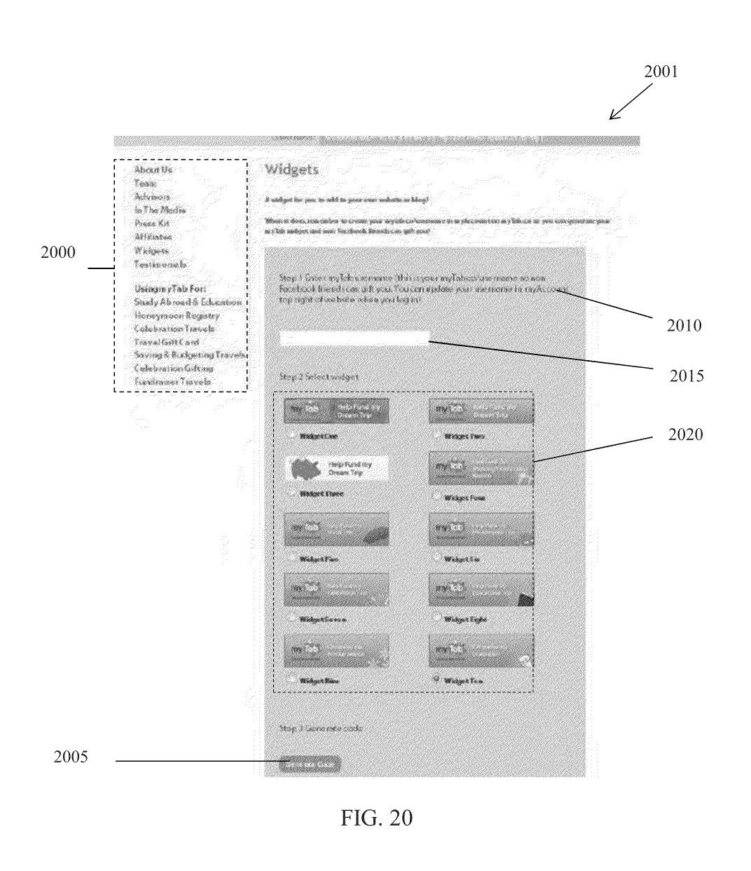

FIG. 20 is a screen shot of one embodiment of a webpage in conjunction with the present invention and shows the webpage for adding a widget. As shown in FIG. 20 the webpage 2001 preferably includes: informational links 2000; widget selection instructions 2010; a username input field 2015; a widget selection area 2020; and a generate code button 2005. The informational links 2000 preferably include links to various webpages that provide additional information for the system of managing travel. Examples of such webpages linked to the informational links 200 may include information such as navigating through the website and adding a new user account. The widget selection instructions 2010 preferably include information that guides the user through the process of creating a widget. The username input field 2015 preferably allows the user to input a username that is associated with a widget. The widget selection area 2020 preferably includes one or more widgets or widget icons to select from for monitoring aspects of the trip and plans for the trip. The generate code button 2005 preferably generates the widget code based on the user's vanity username dedicated to them alone within the invention, which is preferably used to be embedded to one or more websites, webpages, or software applications.

FIG. 20 also shows that users can click the ‘add widget’ link which allows the users to embed an image widget into their blog. This is typically performed by adding their username into the widget title that generates a code. When user's friends see one of the various images on the blog, the friends may click this, and it will preferably take them to the friend's dedicated invention page username where they can provide travel funds through an online money transfer website such as Paypal® without signing into website of the present invention.

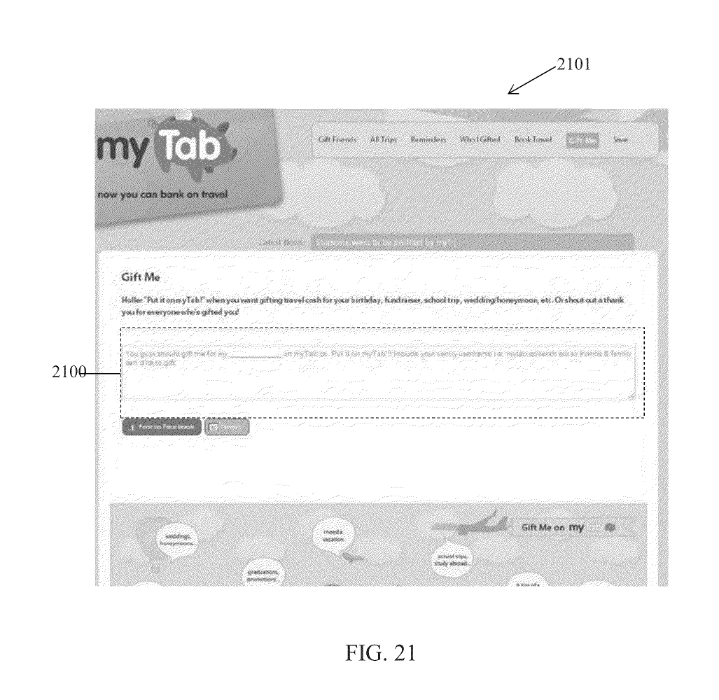

FIG. 21 is a screen shot of one embodiment of a webpage of the present invention and shows how a user may add a request for travel funds. As shown in FIG. 21, the webpage 2101 preferably includes a message input field 2100. The message input field 2100 preferably provides the user with an area to input information for requesting funds for the trip of the user.

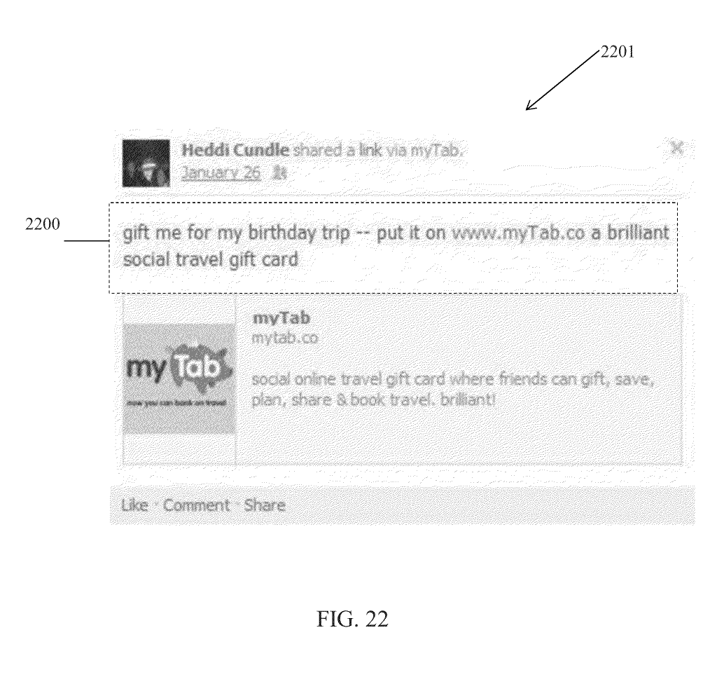

FIG. 22 is a screen shot of one embodiment of a notification in a social media site after a request for travel funds has been made by the user. As shown in FIG. 22, the notification 2201 preferably includes a gift me message 2200. The gift me message 2200 preferably is a request from the user to provide the user travel funds to the savings travel account or gift card.

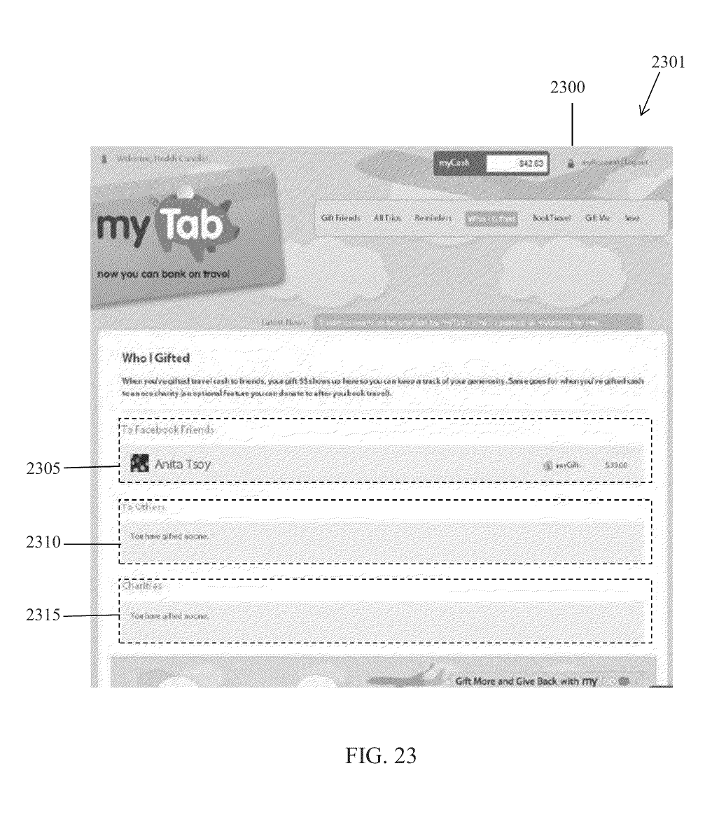

FIG. 23 is a screen shot of one embodiment of a webpage of the present invention and shows a history of funds that are gifted to other users. As shown in FIG. 23, the webpage 2301 preferably includes a balance 2300; a social media network gift history 2305; a charities gift history 2310; and others gift history 2315. The balance 2300 preferably displays the balance of a user's savings account or gift card. The social media network gift history 2305 preferably records and displays all the gifts from the user to members of their social network. The charities gift history 2310 preferably displays all the gifts from the user to various charities. The others gift history 2310 preferably displays all the gifts made to people not included in the social network or charity categories.

FIG. 23 also shows that users may see who they have gifted or provided travel funds. Users preferably see the friend's name and the amount of money gifted or transferred. This is generally broken down into social media friends, non-social media friends, and any charitable contributions given once a trip is booked. The charitable contribution feature is preferably only available once a trip is booked.

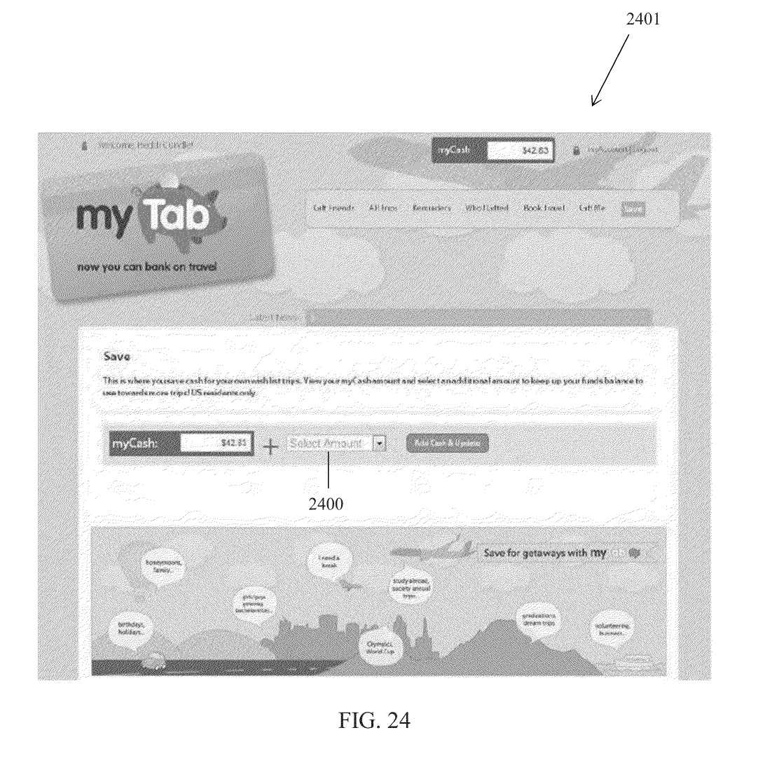

FIG. 24 is a screen shot of one embodiment of a webpage of the present invention and shows how a user can save funds for a trip. As shown in FIG. 24, the webpage 2401 preferably includes a money selection drop down menu 2400. The money selection drop down menu 2400 preferably offers the ability to add discrete sums of money to the user's gift card for use in purchasing trip options. The drop down menu 2400 generally includes amounts in standard increments $10 or $100, but any incremental amount may be used. Although FIG. 24 shows a drop down menu, it should be understood that the present invention allows the use of input fields to enter a specific amount of funds to save.

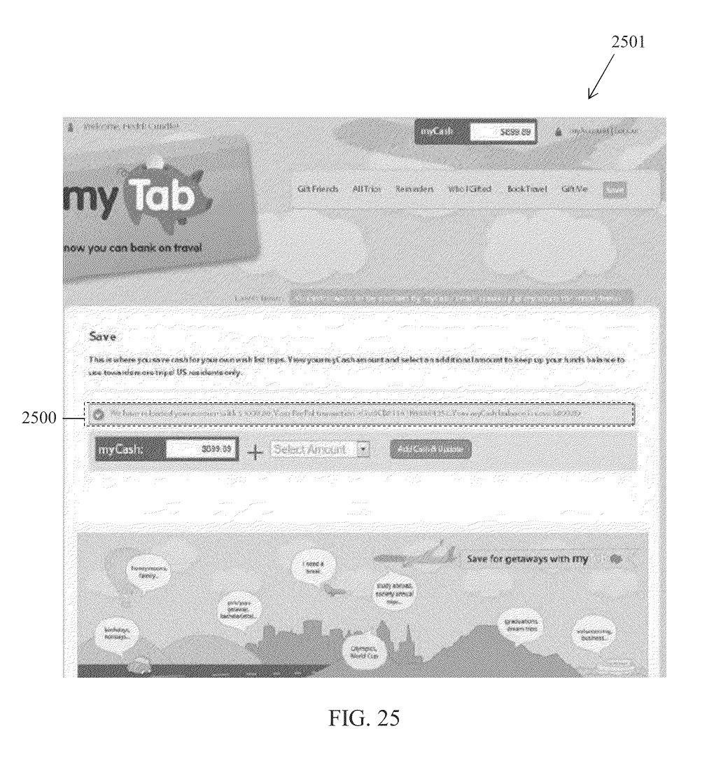

FIG. 25 is a screen shot of one embodiment of webpage of the present invention and shows a confirmation when money has been saved by the user. As shown in FIG. 25, the webpage 2501 preferably includes a confirmation message 2500. The confirmation message 2500 preferably indicates that a transaction has been completed successfully by the user and that the funds were added to their gift card. Once the user has saved travel funds towards his or her saved funds, the confirmation and transaction identification number along with the amount of funds added to their account is preferably shown. Preferably, the right boxes show the current funds in the user's account.

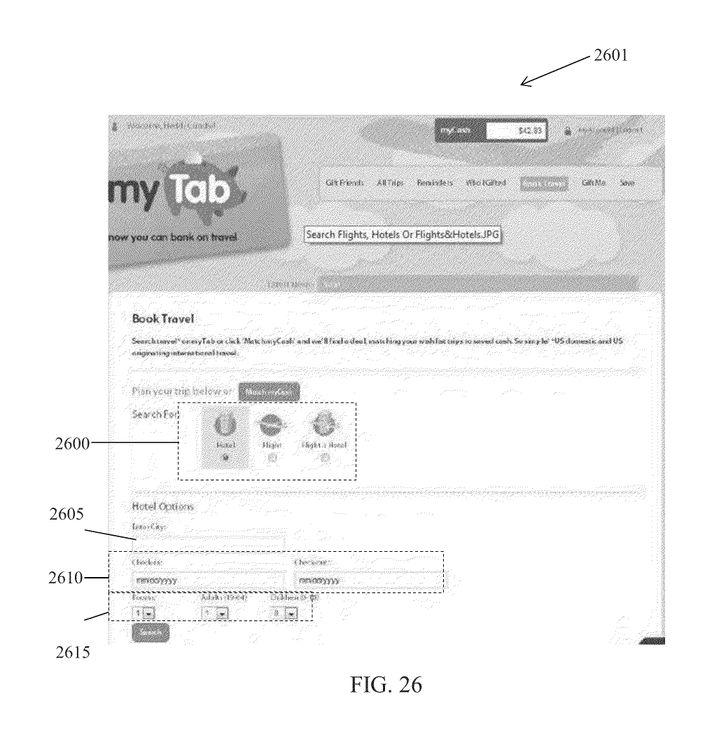

FIG. 26 is a screen shot of one embodiment of a webpage of the present invention and shows the webpage where a user may book a trip. As shown in FIG. 26, the webpage 2601 preferably includes: a booking selection buttons 2600; a hotel city input field 2605; a hotel check-in and check-out drop-down menu 2610; and a number of people drop-down menu 2615. The booking selection buttons 2600 preferably contains the options of booking a hotel, flight, or hotel and flight. The hotel city input field 2615 preferably allows the user to input their target destination city. The hotel check-in and check-out drop-down menu 2610; preferably allows a user to select the beginning and end dates that the user wishes to stay in the city entered into the hotel city input box. The number of people drop-down menu 2615 preferably contains options for how many children, adults, and seniors are to attend the trip.

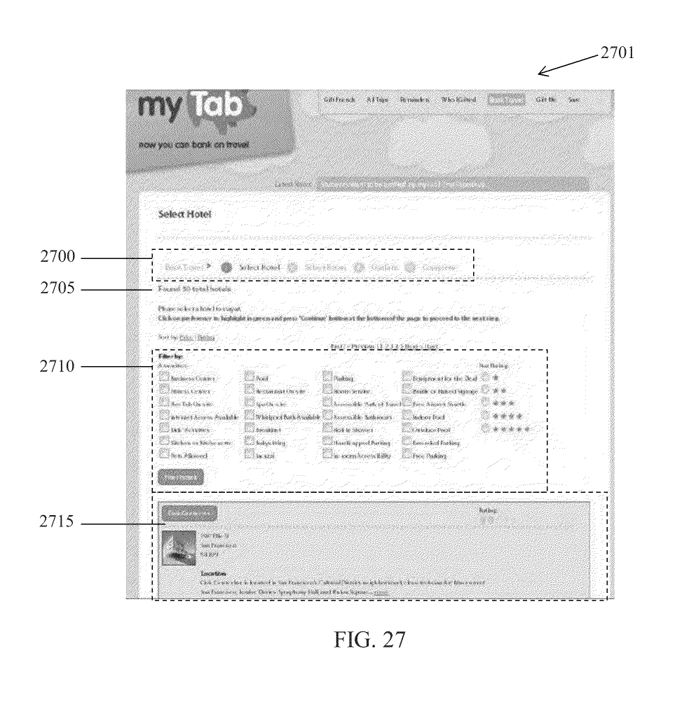

FIG. 27 is a screen shot of one embodiment of a webpage of the present invention and shows how a user may search a hotel. As shown in FIG. 27, the webpage 2701 preferably includes: a booking progress chart 2700; an options indicator 2705; filters 2710; and hotel information 2715. The booking progress chart 2700 preferably displays how much of the booking process has been completed. The options indicator 2705 preferably displays how many total results matched the search criteria. The filters 2710 help to narrow down the options based on criteria determinable by the user. The hotel information 2710 preferably displays detailed information of the selected hotel.

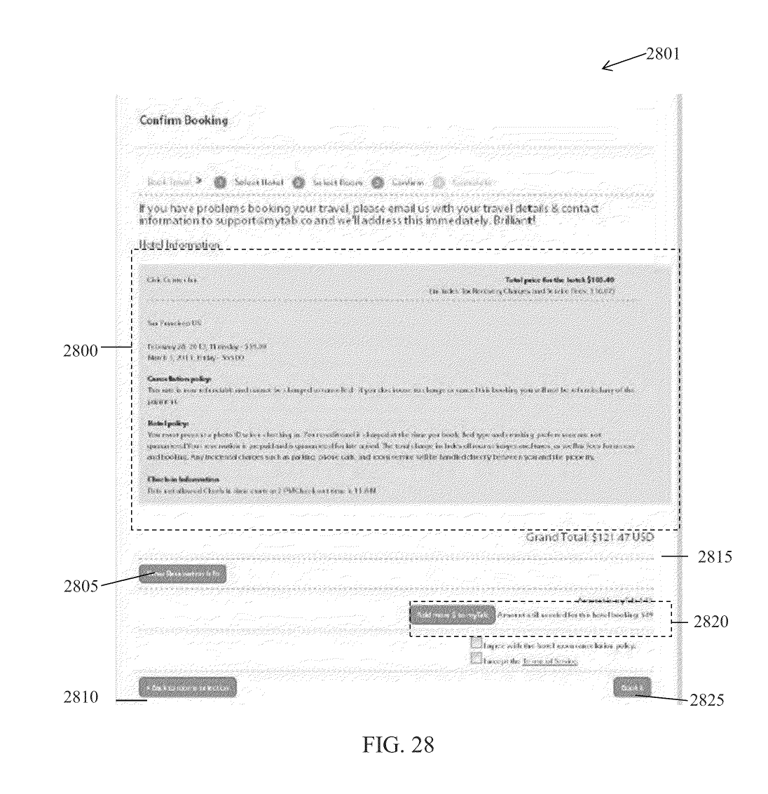

FIG. 28 is a screen shot of one embodiment of a webpage of the present invention and shows a problem notification to the user regarding booking. As shown in FIG. 28, the website 2801 preferably includes: information regarding the selected hotel 2800; a reservation viewing button 2805; return button 2810; total cost 2815; add funds button 2820; and a booking button 2825. The selected hotel 2800 preferably displays information regarding the booking of a specific hotel such as a date, time, cancellation policy, hotel policy and check in information. The reservation viewing button 2805 preferably allows the user to view booking information such as time and date. The return button 2810 preferably allows a user to return to a previous stage in the booking process. The total cost 2815 preferably shows the cost of the trip or hotel booked. The add funds button 2820 preferably allows a user to add funds to their gift card if he or she has insufficient funds to book the trip or hotel. The booking button 2825 preferably charges the grand total to the gift card and books the trip or hotel.

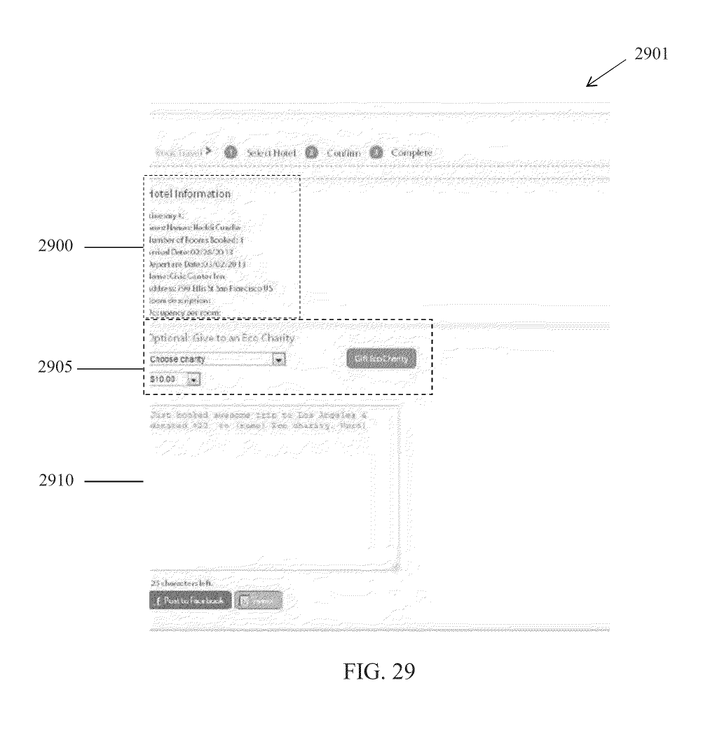

FIG. 29 is a screen shot of one embodiment of a webpage of the present invention and shows a confirmation page when booking the flight. As shown in FIG. 29, the completed booking website 2901 preferably includes: a hotel information 2900; a gift to charity option 2905; and a social media message input field 2910. The hotel information 2900 preferably displays information about the hotel and reservation made. The gift to charity option 2905 preferably allows the user to select a charity and a donation amount to be given to the charity. The social media message input field 2910 preferably allows a user to post a message at various social media sites.

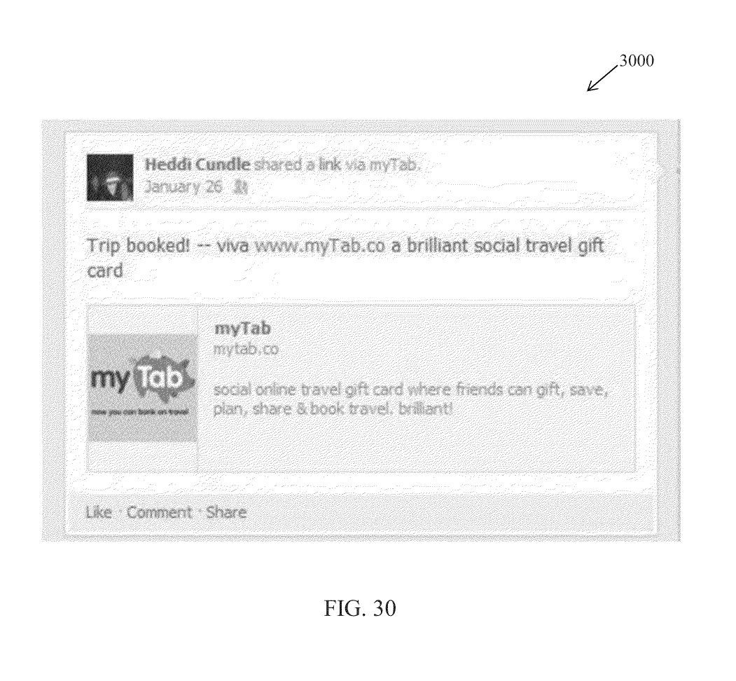

FIG. 30 is a screen shot of one embodiment of a booking notification to a social media site of the present invention. Once a user has booked his or her trip, a notification 3000 may be displayed in various social media sites such as Facebook® and Twitter®.

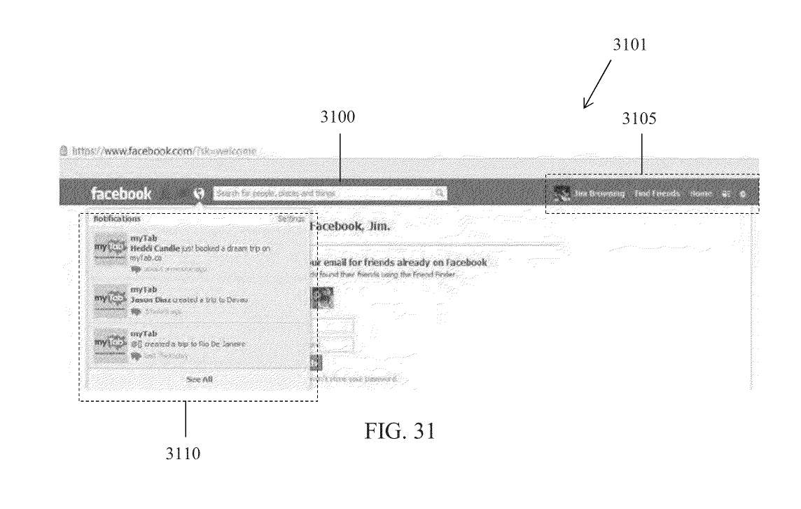

FIG. 31 is a screen shot of another embodiment of a notification in a social media site of the present invention. As shown in FIG. 31, the notification 3101 to a social media site preferably includes: a search bar 3100; a navigation area 3105; and a notification box 3110. The search bar 3100 preferably allows for a search by keyword of people, places, and things. The navigation area 3105 preferably allows the user to navigate the social media site. The notification box 3110 preferably displays various announcements made in conjunction with the present invention, as well as unrelated notifications.

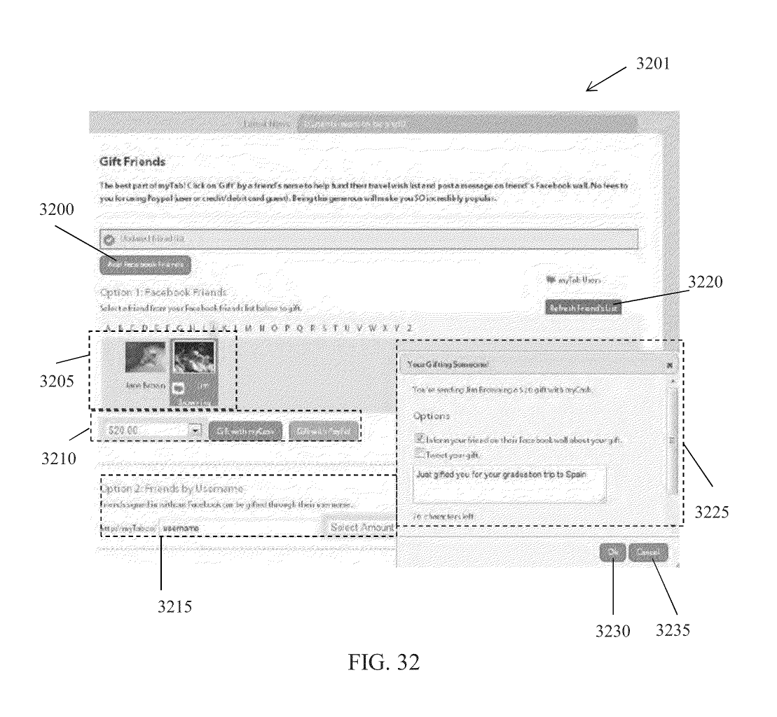

FIG. 32 is a screen shot of one embodiment of a website of the present invention and shows how users can send travel funds to their social media, non-social media, and socially integrated friends. As shown in FIG. 32, the webpage 3201 preferably includes: an add friends button 3200; contact list 3205; refresh button 3220; gift amount drop down menu 3210; dedicated vanity username search field 3215; message window 3225; confirmation button 3230; and cancel button 3235. The add friends button 3200 preferably allows the user to add existing social media friends to join the system. The contact list 3205 preferably allows the user to select existing friends to gift. The gift amount drop down menu 3210 preferably allows the user to select an amount of funds to gift to another user. The dedicated vanity username search field 3215 preferably allows the user to search for another user by name or username. The message window 3225 preferably allows users to compose and send a message to someone they are gifting to. The confirmation button 3230 preferably completes the transaction. The cancel button 3235 preferably stops the transaction.

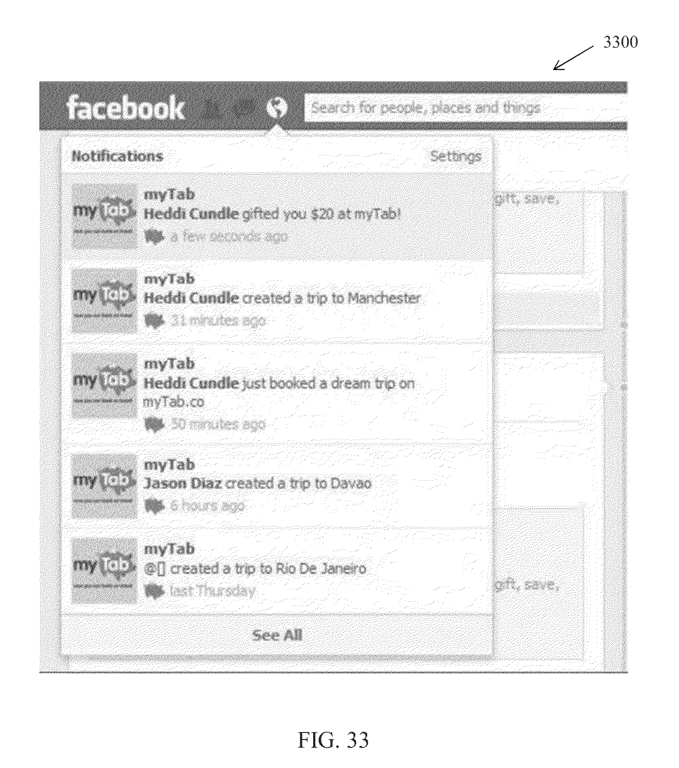

FIG. 33 is a screen shot of another embodiment of a notification in a social media website in conjunction with the present invention and shows the notification after a gift has been sent by the user. Once a user has sent funds to another user, a notification 3300 may be displayed in various social media sites such as Facebook® and Twitter®.

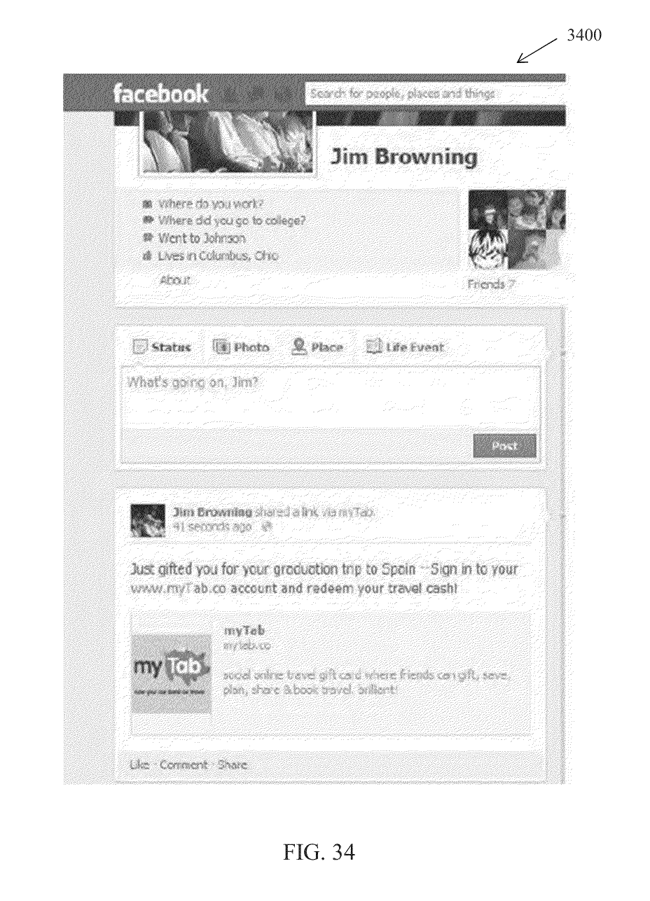

FIG. 34 is a screen shot of one embodiment of a notification in a social media website in conjunction with the present invention and shows a comment field where a user may provide comments or messages. Specifically, when users send a gift their social media friends in the social media site, their friends have an option to write a message in a social media site such as the wall post. This message preferably posts to the recipient's social media webpage, in real time. The recipient preferably clicks the link and may be routed to the website of the present invention. Even if the recipient is not a user of the present invention, when a recipient signs up for the user account for the first time, funds will preferably be waiting for recipient towards a trip.

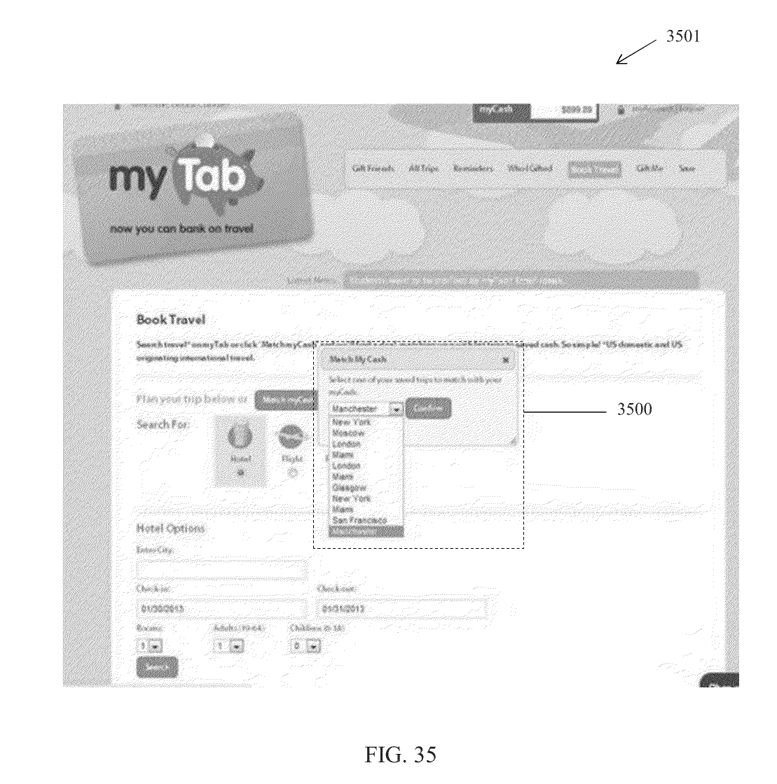

FIG. 35 is a screen shot of one embodiment of webpage in conjunction with the present invention and shows travel options based upon a set saved funds. The webpage 3500 may offer the user an option of searching travel and using their funds towards a trip destination. These options are preferably based upon the funds within the user's current balance for both exclusive and non-exclusive deals. Specifically, users may let the website of the present invention send a notification email, detailing them a deal that matches a threshold of approximately within 15% of their current funds, also known as “Match myCash”. Users can click the link and book travel. However, if the users have insufficient funds within the threshold of approximately 15%, the user can add the funds instantly through online money transfer website such as PayPal®, and route such funds back to the website to book their trip. Preferably, exclusive deals are aggregated by certain affiliated suppliers, and negotiations are preferably made with travel suppliers (e.g., airlines, hotels, and/or car rentals) to offer deals that are exclusive to the users. These may be negotiated by crowd funding opportunities—i.e., the more funds users hold in their account, the lower the rate that may be negotiated. Suppliers may bid for well-funded users who intend to travel to various destinations and the larger the saved funds, the lower the supply and demand bid that may be negotiated by the invention.

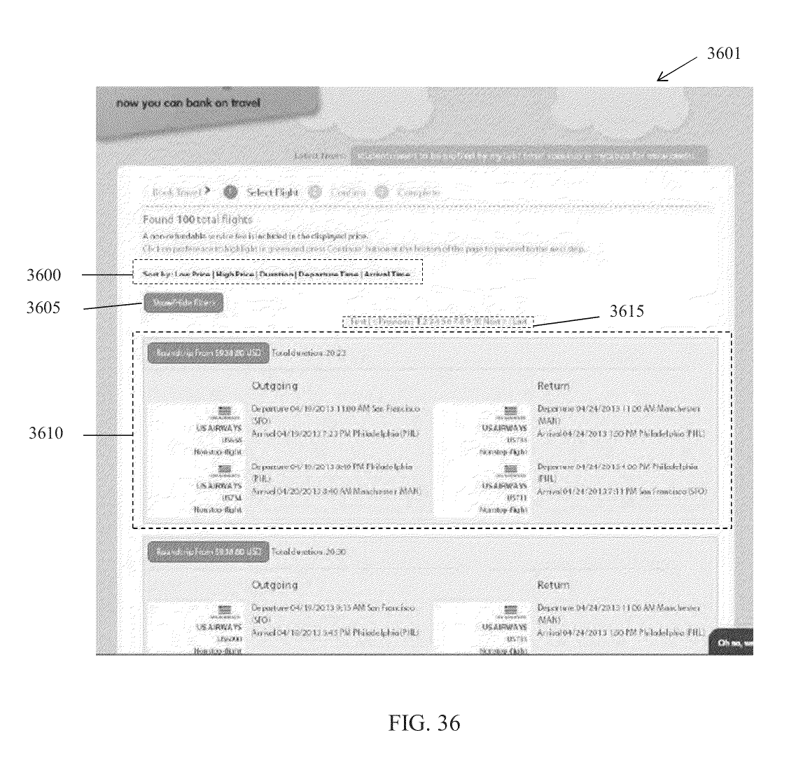

FIG. 36 is a screen shot of one embodiment of a webpage of the invention and shows the travel options to the user. As shown in FIG. 36, the webpage 3601 preferably includes: filter options 3600; show/hide filter button 3605; travel options 3610; and search results 3615. The travel options 3610 are preferably displayed based on funds that are within 15% of funds that are available by the user. This typically enables users to freely search without focusing on the price factor as the user generally will have within 15% of the funds available for all these travel options 3610. Although the travel options are shown within 15% of the available funds of the user, it should be understood that the present invention allows the travel options to appear within various thresholds such as 20%, 25%, 30%, 50%, or even higher. Examples of travel options 3610 are hotels and/or flights available to the user. These travel options 3610 may be filtered by the filter options 3600, and the filter options 3600 may be hidden or shown by selecting the show/hide filter button 3605. The user can also navigate various pages if there are many search results 3615.

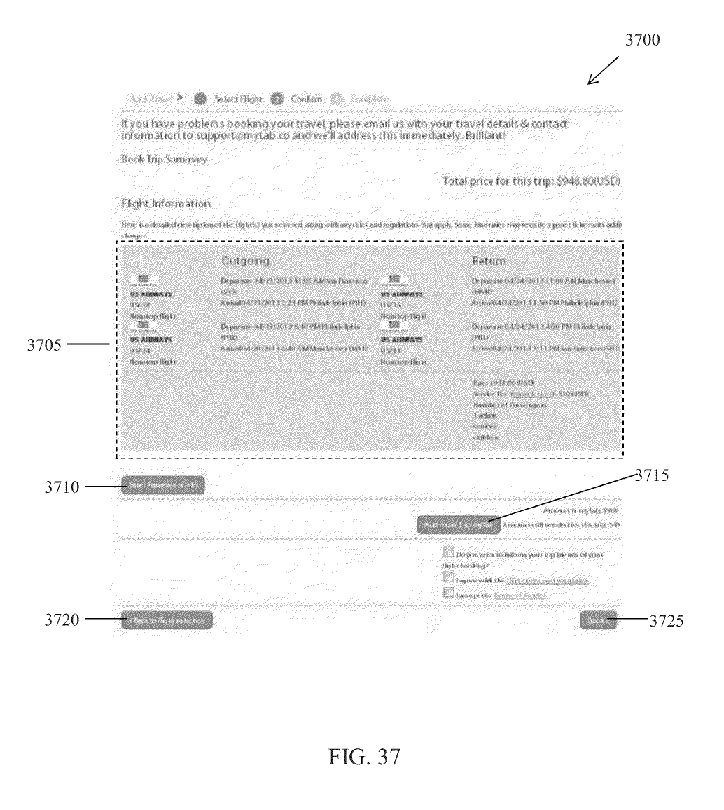

FIG. 37 is a screen shot of one embodiment of a webpage of the invention and shows the finalization webpage when booking a trip. As shown in FIG. 37, the finalization webpage 3700 preferably includes: travel information 3705; passenger information button 3710; add funds button 3715; return button 3720; and book it button 3725. The travel information 3705 preferably provides detailed information about the flight and/or hotel information before booking. The passenger information button 3710 preferably allows the user to enter another webpage to enter user information for the flight. The add funds button 3715 preferably allows the user to add more funds into his or her gift card or savings account. The return button 3720 preferably allows the user to return to the previous webpage. The book it button 3705 preferably allows the user to book the trip based upon the information on the finalization webpage.

FIG. 37 also shows that, upon finalizing their trip, if users are short of funds within a threshold of their balance (e.g., 15%), the users are typically notified to add more funds. The user may select the add funds button 3715 and be routed to an online money transfer website such as PayPal® where the user may add the required funds. The user is then preferably routed back to website of the present invention to complete his or her booking. Users typically cannot book a trip if his or her funds are insufficient.

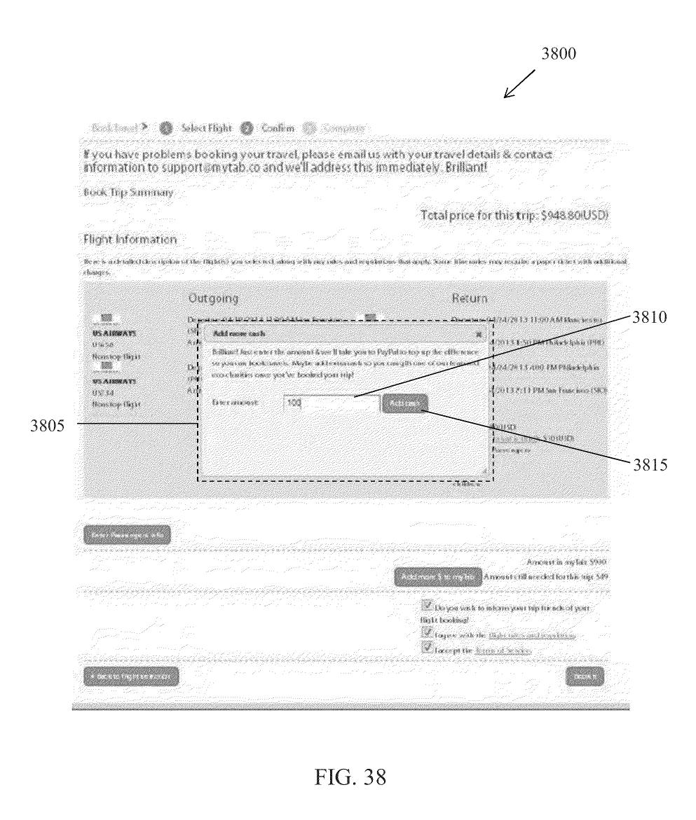

FIG. 38 is a screen shot of one embodiment of a webpage of the invention and shows how a user may add funds. As shown in FIG. 38, the webpage 3800 preferably includes: add funds window 3805; input field 3810; and submit button 3815. The add funds window 3805 is preferably a pop-up window that allows a user to enter an amount to route the desired funds from his or her bank account to the travel savings account or gift card. The input field 3810 is preferably an input field where the user may indicate the amount of funds that he or she would like to add. The submit button 3815 is preferably the button to submit the desired amount to the travel savings account or gift card.

FIG. 38 also shows that, the add funds window generally requires the user to indicate the amount of funds the user would like to add to his or her balance. Once the user selects the desired amount, the user is generally routed to an online money transfer website such as PayPal® where the user may add the required funds. The user is generally then routed back instantly to website of the present invention to complete the booking process. The user, however, preferably cannot book a trip if the user's funds do not match or exceed the travel price.

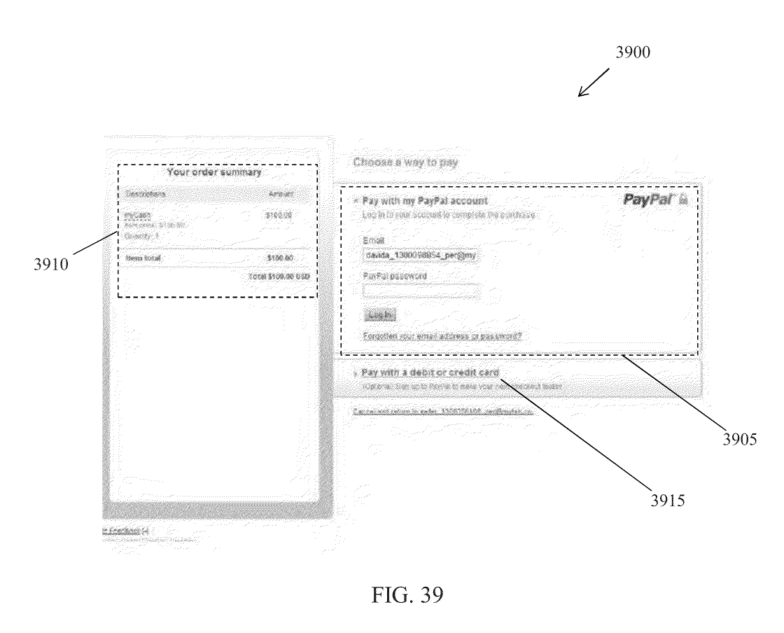

FIG. 39 is a screen shot of one embodiment of a webpage of an online money transfer website of the invention. As shown in FIG. 39, the webpage of an online money transfer website 3900 preferably includes: login information 3905; order summary 3910; and credit card/debit card option 3915. The login information 3905 preferably allows the user to login his or her information into the online money transfer website. The login information 3905 generally includes a user name input field where the user may input his username or email address. The login information 3905 also may include a password input field where the user may input his or her password to login the online money transfer website. The login information 3905 may also other features such as forgot username and/or forgot password link. The order summary 3910 is preferably the area of the online money transfer website that provides information as to the amount of money the user desires to transfer. The add credit card/debit card option 3915 preferably allows the user to add funds from his or her credit card or debit card rather than bank checking account.

Preferably, the online money transfer website provides a plugin routing page for gifting users funds, saving funds, and adding funds before booking (generally when the user's funds are insufficient for booking). Once the user adds the funds through the online money transfer website (or through the user's credit card or debit card), the user is generally routed back to the finalization booking page. Preferably, once the funds are transferred, the user will see a notification stating that the funds are transferred, a transaction identification number, and a confirmation page from the online money transfer website.

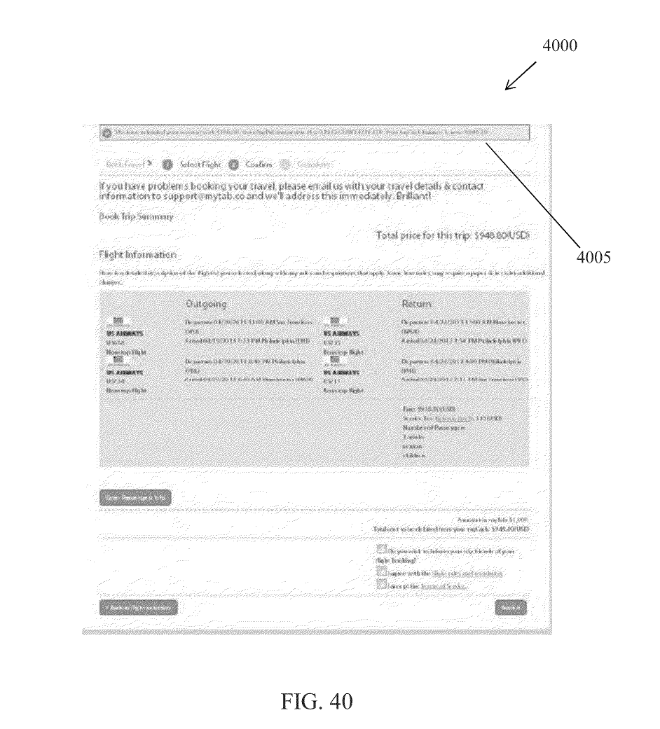

FIG. 40 is a screen shot of one embodiment of a webpage of an online money transfer website of the invention and shows a notification after funds are transferred. As shown in FIG. 40, the webpage 4000 preferably includes a notification 4005. Once the user has added funds to his or her account that matches or exceeds the required travel price, the user can preferably book the trip. The notification 4005 is preferably a confirmation that the funds are added. Generally, the website and online money transfer website would email the user of this transaction.

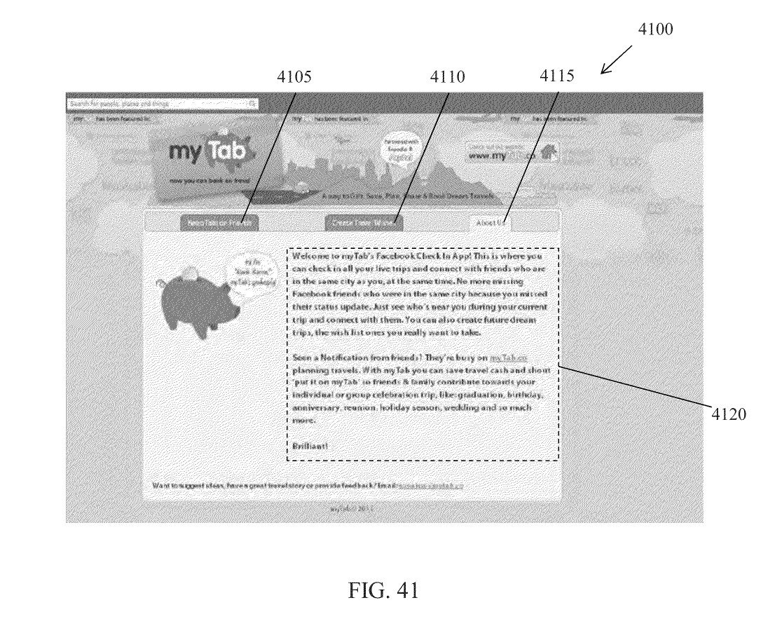

FIG. 41 is a screen shot of one embodiment of the invention and shows how a user may create a wish list. As shown in FIG. 41, the webpage 4100 preferably includes: monitor friends button 4105; create wish list button 4110; and about us button 4115. The monitor friends button 4105 preferably allows the user to monitor and track friends of social media sites according to the friend's travel plans. The create wish list button 4110 preferably allows the user to create a wish list for current or future travel events. The about us button 4115 preferably provides information 4120 of the website of the present invention.

FIG. 41 also shows that the present invention preferably includes an application where users and the user's friends/family can create a wish list for trips. For example, regarding current trips, users may add the current trips by start and end date, destination, purpose of the trip, and a calculator to assess the average trip price cost. Preferably, the next page shows a map where the friend or user is located currently during their travels. This feature preferably enables social media friends to connect during travels. However, the present invention generally prevents anyone from seeing notifications of the user's friend's current trips.

Regarding wish list trips, the present invention allows users to plan future trips. Specifically, user may add the start and end date of the trip, purpose, and destination and invite traveling social media friends. This information is preferably synched to the website of the present invention. Preferably, this webpage allows the user to keep in touch or monitor other people via a social networking application.

FIG. 41 is a screen shot of one embodiment of a webpage of the invention and shows information after a user selects the monitor friends button. As shown in FIG. 41, the webpage 4200 preferably includes a map 4205 and location information 4210. After the user selects the monitor friends button 4105, a map 4205 would appear indicating one or more location information 4210. Preferably, the location information 4210 is information as to the date and location of a specific friend who is traveling. Specifically, the present invention allows users to see where friends are currently located by destination, start and end date of the trip, and the purpose behind the trip. Preferably, the present invention allows the user to see their friend in real time and connect to create travel memories together.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method of managing travel arrangements, the steps comprising:
registering on one or more computers by one or more users on a system for managing travel;
wherein said system for managing travel is on a server;
creating one or more gift cards;
wherein each of said one or more gift cards functions as a travel savings account;
linking said one or more gift cards to said one or more registered users of said system for managing travel;
accessing on said one or more computers by said one or more users said system for managing travel;
providing on said one or more computers a plurality of travel options to said one or more users accessing said system for managing travel;
wherein said plurality of travel options on said system for managing travel is provided by one or more suppliers;
wherein said providing step of said plurality of travel options is generated based upon said set amount of funds saved by a first registered user in said linked gift card of said first registered user's linked gift card;
selecting by said first registered user one or more of said plurality of travel options on said system for managing travel;
providing one or more notifications to said first registered user after said first registered user selects one or more of said plurality of travel options; and
paying for said selected one or more of said plurality of travel options from said set amount of funds saved in said first registered user's linked gift card.

2. The computer-based method of managing travel arrangements of claim 1, the steps further comprising:
rewarding said one or more users with one or more rewards points;
wherein said one or more rewards points are applied to redeem said plurality of travel options; and
alerting said one or more users one or more expiration dates of said one or more rewards points.

3. The computer-based method of managing travel arrangements of claim 2, wherein said one or more rewards points is based on saving a plurality of funds in said one or more gift cards; and
wherein said one or more rewards points is based on purchasing said one or more of said plurality of travel options.

4. The computer-based method of managing travel arrangements of claim 2, wherein said set amount to generate said plurality of travel options is approximately within a threshold between −15% to 15% of said set saved funds in said gift card.

5. The computer-based method of managing travel arrangements of claim 2, wherein said set amount to generate said plurality of travel options is approximately within a threshold between −20% to 20% of said set amount of funds saved in said one or more gift cards.

6. The computer-based method of managing travel arrangements of claim 2, wherein said providing step of said one or more notifications is performed in one or more social media sites.

7. The computer-based method of managing travel arrangements of claim 2, wherein said one or more rewards points are based on purchasing selected one or more of said plurality of travel options from said system for managing travel with said set amount of funds saved in said one or more gift cards.

8. The computer-based method of managing travel arrangements of claim 2, wherein said one or more rewards points are used by said one or more users to offset paying for said selected one or more of said plurality of travel options.

9. The computer-based method of managing travel arrangements of claim 6, wherein said notification on one or more social media sites is one or more postings in said one or more social media sites.

10. The computer-based method of managing travel arrangements of claim 2, wherein said one or more users is a plurality of users and wherein said plurality of users form a travel group; and
selecting by said travel group said one or more of said plurality of travel options;
providing one or more notifications to said travel group after said travel group selects said one or more of said plurality of travel options.

11. The computer-based method of managing travel arrangements of claim 1, wherein one or more third parties add a plurality of additional funds to said set amount of funds saved in said one or more gift cards.

12. The computer-based method of managing travel arrangements of claim 11, wherein said plurality of travel options includes one or more exclusive deals to said one or more registered users from said one or more suppliers.

13. The computer-based method of managing travel arrangements of claim 12, the steps further comprising:
providing a calendar alert function within said system for managing travel;
inputting a plurality of calendar alert data into said calendar alert function;
wherein said plurality of calendar alert data is selected from the group of data consisting of: future trip data; wish list data; third party gift giving data; personal gift giving data; popular event data; available funds data; funds needed to book a future trip data; and exclusive deals data; and
notifying said one or more users by said calendar alert function of one or more of said plurality of calendar alert data.

14. The computer-based method of managing travel arrangements of claim 13, the steps further comprising:
modifying and updating said plurality of calendar alert data.

15. The computer-based method of managing travel arrangements of claim 14, the steps further comprising:
personalizing said system for managing travel;
personalizing said plurality of calendar alert data; and
creating a wish list of said plurality of travel options.

16. The computer-based method of managing travel arrangements of claim 15, wherein said one or more users are notified by said calendar alert function of one or more of said plurality of calendar alert data by the group consisting of: an email notification; a text notification; a smart phone application notification; and a desktop application notification.

17. The computer-based method of managing travel arrangements of claim 16, wherein said selecting step of said one or more of said plurality of travel options produces a notification on one or more social media sites.

18. The computer-based method of managing travel arrangements of claim 17, wherein said wish list of said plurality of travel options is posted in one or more social media sites.

19. The computer-based method of managing travel arrangements of claim 2, wherein said plurality of travel options includes one or more exclusive deals to one or more registered users from a plurality of suppliers; and
wherein said one or more exclusive deals are based upon approximately within a threshold between −15% to 15% of said set amount of funds saved in said one or more gift cards.

20. A computer-based method of managing travel arrangements, the steps comprising:
registering on one or more computers by one or more users on a system for managing travel;
wherein said system for managing travel is on a server;
creating one or more gift cards;
wherein each of said one or more gift cards functions as a travel savings account;
linking said one or more gift cards to said one or more registered users of said system for managing travel;
accessing on said one or more computers by said one or more users said system for managing travel;
providing on said one or more computers a plurality of travel options to said one or more users accessing said system for managing travel;
wherein said plurality of travel options on said system for managing travel is provided by one or more suppliers;
wherein said plurality of travel options includes one or more exclusive deals to said one or more registered users from said one or more suppliers;
wherein said providing step of said plurality of travel options is generated based upon said set amount of funds saved by a first registered user in said linked gift card of said first registered user's linked gift card;
wherein said set amount to generate said plurality of travel options is approximately within a threshold between −15% to 15% of said set saved funds in said gift card;
selecting by said first registered user one or more of said plurality of travel options on said system for managing travel;
providing one or more notifications to said first registered user after said first registered user selects one or more of said plurality of travel options;
wherein said selecting step of said one or more of said plurality of travel options produces a notification on one or more social media sites;
wherein said providing step of said one or more notifications is performed in one or more social media sites;
wherein said notification on one or more social media sites is one or more postings in said one or more social media sites;
paying for said selected one or more of said plurality of travel options from said set amount of funds saved in said first registered user's linked gift card;
rewarding said one or more users with one or more rewards points;
wherein said one or more rewards points is based on saving a plurality of funds in said one or more gift cards;
wherein said one or more rewards points is based on purchasing said one or more of said plurality of travel options;
wherein said one or more rewards points are used by said one or more users to offset paying for said selected one or more of said plurality of travel options;
wherein said one or more rewards points are applied to redeem said plurality of travel options;
alerting said one or more users one or more expiration dates of said one or more rewards points;
wherein said one or more users is a plurality of users and wherein said plurality of users form a travel group;
selecting by said travel group said one or more of said plurality of travel options;
providing one or more notifications to said travel group after said travel group selects said one or more of said plurality of travel options;
wherein one or more third parties add a plurality of additional funds to said set amount of funds saved in said one or more gift cards;
providing a calendar alert function within said system for managing travel;
inputting a plurality of calendar alert data into said calendar alert function;
wherein said plurality of calendar alert data is selected from the group of data consisting of: future trip data; wish list data; third party gift giving data;
personal gift giving data; popular event data; available funds data; funds needed to book a future trip data; and exclusive deals data;
notifying said one or more users by said calendar alert function of one or more of said plurality of calendar alert data;
wherein said one or more users are notified by said calendar alert function of one or more of said plurality of calendar alert data by the group consisting of: an email notification; a text notification; a smart phone application notification;
and a desktop application notification;
modifying and updating said plurality of calendar alert data;
personalizing said system for managing travel;
personalizing said plurality of calendar alert data;
creating a wish list of said plurality of travel options;
wherein said wish list of said plurality of travel options is posted in one or more social media sites.
